(19) United States
(12) Patent Application Publication
(10) Pub. No.: US 2019/0230270 A1
(43) Pub. Date: Jul. 25, 2019

(54) IMAGE CAPTURING APPARATUS AND METHOD FOR CONTROLLING THE SAME

(71) Applicant: CANON KABUSHIKI KAISHA, Tokyo (JP)

(72) Inventors: Takeshi Uchida, Yokohama-shi (JP); Goro Noto, Tokyo (JP)

(21) Appl. No.: 16/251,274

(22) Filed: Jan. 18, 2019

(30) Foreign Application Priority Data
Jan. 22, 2018 (JP) 2018-008164

(51) Int. Cl. H04N 5/235; H04N 5/225; H04N 5/232

(52) U.S. Cl. CPC H04N 5/2353; H04N 2005/44565; H04N 5/232; H04N 5/2256

(57) ABSTRACT

An image capturing apparatus comprising: a light-amount control element that changes a transmittance of light; an image sensor that photoelectrically converts light that has passed through the light-amount control element and changes an exposure amount by intermittently accumulating charges in a predetermined cycle in each frame; and a controller that controls the transmittance of the light-amount control element and the exposure amount controlled by the image sensor so as to achieve a preset target exposure amount.

### BACKGROUND OF THE INVENTION

### Field of the Invention

The present invention relates to an image capturing apparatus and a method for controlling the same, and more specifically to an image capturing apparatus that has a light-amount control element configured to change the transmittance of light, and a method for controlling the same.

### Description of the Related Art

A technique for attenuating the light intensity of a subject using a light attenuation member such as an ND filter in a conventional image capturing apparatus is known. For example, by selecting an appropriate light attenuation ratio according to the brightness of an imaging scene using variable ND filters with different density related to the light attenuation ratio, an image (or video) with brightness desired by a user can be acquired.

An optical variable light attenuation means such as a liquid crystal element or an element in which an inorganic electrochromic (EC) thin film (referred to as “EC device” hereinafter) is used has been proposed as the variable ND filter. Japanese Patent No. 4384730 and Japanese Patent Laid-Open No. 6-301065 propose techniques for obtaining effects that are similar to those of conventional ND filters by utilizing coloring and decoloring techniques using an EC device material or the like.

On the other hand, controlling charge accumulation in an image sensor without using an optical element such as an ND filter makes it possible to control the brightness of an imaging scene. Japanese Patent Laid-Open No. 2010-157893 discloses a technique in which charges converted by a photoelectric conversion unit are transferred to an accumulation unit a plurality of times, the transferred charges are accumulated collectively, and thus conditions such as an exposure time period and an exposure amount can be freely changed at high speed.

However, with the techniques proposed in Japanese Patent No. 4384730 and Japanese Patent Laid-Open No. 6-301065, when a current passes through an EC layer in the EC device so as to drive the EC device, a predetermined stabilization period is required until coloring or decoloring according to a reaction time period of an oxidation-reduction reaction is complete. Thus, if the EC device is used as a variable ND filter, there is a problem in that it takes time to achieve a desired light attenuation ratio, an instruction from a user or a camera is delayed, and a response to a change in luminance is delayed.

On the other hand, with the technique proposed in Japanese Patent Laid-Open No. 2010-157893, there are cases where the accumulation time period for each instance of charge accumulation in the plurality of times charge accumulation is performed in one frame period shortens depending on the luminance of a subject. In such a case, the resolving power of the shortest exposure time period that can be controlled in the image capturing apparatus deviates from the accumulation period, and fine light amount adjustment cannot be performed.

### SUMMARY OF THE INVENTION

The present invention has been made in consideration of the above situation, and enables fine light amount adjustment with good responsiveness, regardless of the imaging scene.

According to the present invention, provided is an image capturing apparatus comprising one or more processors and/or circuitry which functions as: a light-amount control element that changes a transmittance of light; an image sensor that photoelectrically converts light that has passed through the light-amount control element and changes an exposure amount by intermittently accumulating charges in a predetermined cycle in each frame; and a controller that controls the transmittance of the light-amount control element and the exposure amount controlled by the image sensor so as to achieve a preset target exposure amount.

Furthermore, according to the present invention, provided is a method for controlling an image capturing apparatus including a light-amount control element that changes a transmittance of light and an image sensor that photoelectrically converts light that has passed through the light-amount control element and changes an exposure amount by intermittently accumulating charges in a predetermined cycle in each frame, the method comprising: acquiring a light attenuation amount; and controlling the transmittance of the light-amount control element and the exposure amount controlled by the image sensor so as to achieve a target exposure amount that is based on the light attenuation amount.

Further features of the present invention will become apparent from the following description of exemplary embodiments with reference to the attached drawings.

### BRIEF DESCRIPTION OF TI-IE DRAWINGS

The accompanying drawings, which are incorporated in and constitute a part of the specification, illustrate embodiments of the invention, and together with the description, serve to explain the principles of the invention.

FIGS. 1A and 1B are external views of an image capturing apparatus according to a first embodiment of the present invention.

FIG. 2 is a block diagram showing a schematic functional configuration of the image capturing apparatus according to the first embodiment.

FIG. 3 is a circuit diagram showing a configuration of a portion of an image sensor according to the first embodiment.

FIG. 4 is a timing chart showing a driving sequence of the image sensor according to the first embodiment.

FIG. 5 is an illustrative diagram of an eiectrochromic device that is used as a light-amount control element.

FIG. 6 is a diagram showing a relationship between a response time period and an absorbance of a light-amount control filter in which an electrochromic material is used.

FIGS. 7A and 7B are diagrams illustrating an effect of adjusting the absorbance (light attenuation amount) using an imager ND function and a light-amount control element according to the first embodiment.

FIG. 8 is a flowchart showing a procedure for controlling light attenuation amount according to the first embodiment.

FIGS. 9A to 9C are diagrams showing a schematic configuration of a light-amount control filter and properties of transmittance with respect to an applied voltage according to a second embodiment.

FIG. 10 is a block diagram showing a schematic functional configuration of an image capturing apparatus according to the second embodiment.

FIG. 11 is an external view of an image capturing apparatus according to a third embodiment.

FIG. 12 is a block diagram showing a schematic functional configuration of the image capturing apparatus according to the third embodiment.

FIG. 13 is a circuit diagram showing a configuration of portions of an image sensor according to the third embodiment.

FIG. 14 is a timing chart showing a driving sequence of the image sensor according to the third embodiment.

FIGS. 15A to 15F are diagrams showing potential states corresponding to pulses for driving and controlling the image sensor according to the third embodiment.

FIG. 16 is a timing chart illustrating details of pulses øTX1A(n) and øTX1A(n+1) for driving and controlling the image sensor according to the third embodiment.

FIGS. 17A, 17B, and 17C are flowcharts showing a procedure for controlling light attenuation amount according to the third embodiment.

FIG. 18 is a block diagram showing a schematic functional configuration of the image capturing apparatus according to a fourth embodiment.

FIGS. 19A and 19B are flowcharts showing a procedure for controlling light attenuation amount in the fourth embodiment.

### DESCRIPTION OF THE EMBODIMENTS

Exemplamy embodiments of the present invention will be described in detail in accordance with the accompanying drawings. The dimensions, materials, shapes and relative positions of the constituent parts shown in the embodiments should be changed as convenient depending on various conditions and on the structure of the apparatus adapted to the invention, and the invention is not limited to the embodiments described herein.

### First Embodiment

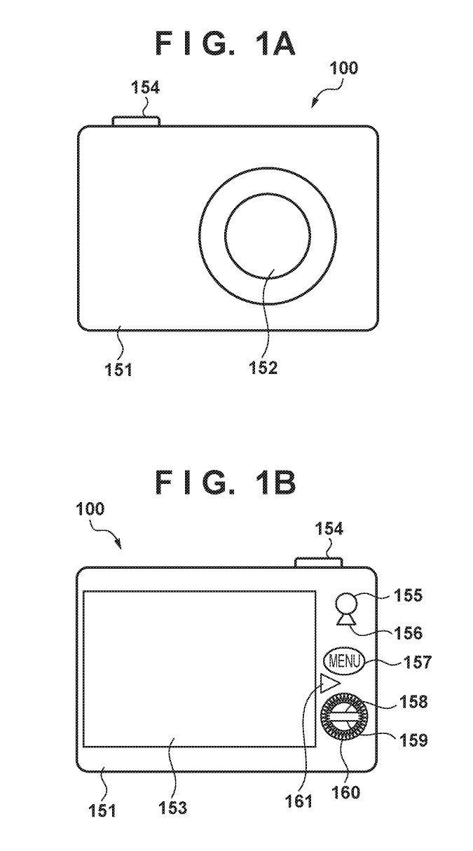

A first embodiment of the present invention will be described. FIGS. 1A and 1B are external views of an image capturing apparatus 100 in the first embodiment, FIG. 1A showing a front view of the image capturing apparatus 100, and FIG. 1B showing a rear view of the image capturing apparatus 100. The image capturing apparatus 100 includes an image capturing apparatus main body 151 that internally houses an image sensor and a shutter apparatus, and an imaging optical system 152 that has a diaphragm therein. Also, a display unit 153 for displaying imaging information or video and various switches are arranged on its back surface and upper surface.

The image capturing apparatus 100 includes, as the switches, a switch 154 that is mainly used to capture still images, a switch 155 that is a button for starting or stopping capturing of a moving image, and an imaging mode selection lever 156 for selecting an imaging mode. Furthermore, the image capturing apparatus 100 includes a menu button 157 for switching to a function setting mode for selling the function of the image capturing apparatus 100, an up-switch 158 and a down-switch 159 for changing various setting values, and a dial 160 for changing various setting values. Also, the image capturing apparatus 100 includes a reproduction button 161 for switching to a reproduction mode for reproducing, on a display unit 153, a video recorded in a recording medium housed in the image capturing apparatus main body 151.

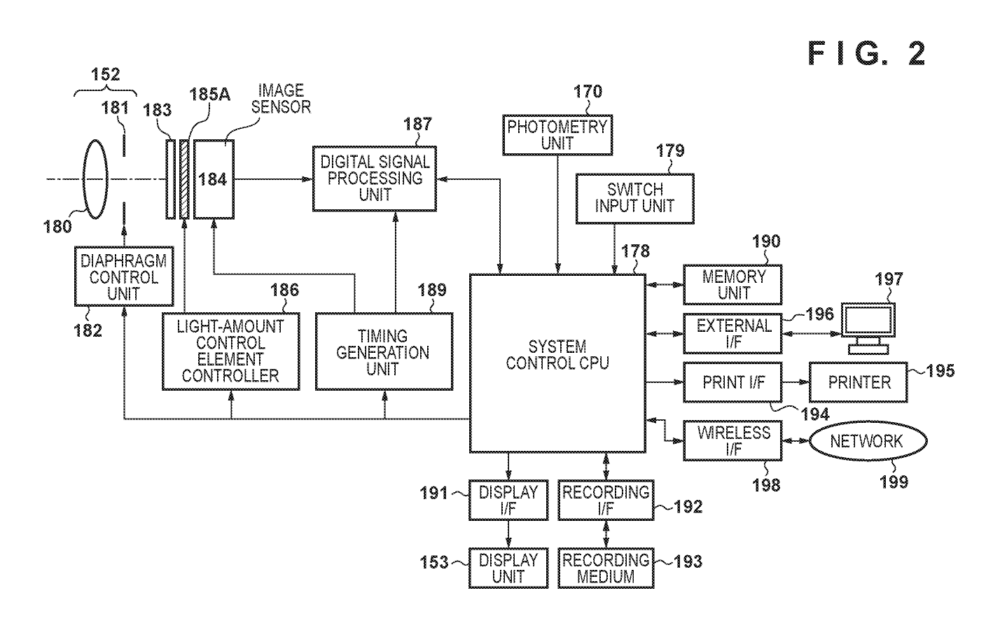

FIG, 2 is a block diagram showing a schematic functional configuration of the image capturing apparatus 100 shown in FIGS. 1A and 1B. The imaging optical system 152 has a lens 180 and the diaphragm 181 for adjusting the light amount. Note that the lens 180 is depicted as one lens in FIG. 2, but is constituted by a plurality of lenses such as a focus lens and a zoom lens in general. An optical filter 183 and a light-amount control element 185A are installed between the diaphragm 181 and the image sensor 184. The aperture of the diaphragm 181 is controlled by a diaphragm control unit 182 based on an exposure value obtained by a system control CPU 178 based on a photometry value obtained by a photometry unit 170. Note that this exposure value is calculated by the system control CPU 178 based on the photometry value obtained by the photometry unit 170.

The optical filter 183 limits the wavelength of light incident on the image sensor 184 and the spatial frequency that is transmitted to the image sensor 184. The light-amount control element 1.85A can change its transmittance, and the light-amount control element 185A attenuates the amount of light incident on the image sensor 184, and the transmittance is controlled by a driving voltage applied by a light-amount control element controller 186.

An optical image of a subject that has been formed by the imaging optical system 152 passes through the optical filter 183 and the light-amount control element 185A, is incident on the image sensor 184, and is converted into an electrical image signal. The image sensor 184 has a sufficient number of pixels, signal readout speed, color gamut, and dynamic range to satisfy Ultra High Definition Television standards, for example. Also, although it is assumed that the image sensor 184 in this first embodiment converts an image signal into digital image data and outputs the resulting data, the conversion to digital image data may be performed outside the image sensor 184.

A digital signal processing unit 187 compresses image data after performing various corrections on the digital image data output from the image sensor 184. The light-amount control element controller 186 sends a signal to the light-amount control element 185A and controls the light-amount control element 185A such that an appropriate light attenuation amount is achieved. A timing generation unit 189 outputs various timing signals to the image sensor 184 and the digital signal processing unit 187. The system control CPU 178 performs various calculations and performs overall control on the image capturing apparatus 100.

A memory unit 190 is used to temporarily store digital image data or the like that is output from the digital signal processing unit 187 via the system control CPU 178. The display unit 153 displays an image captured via a display interface (I/F) unit 191. A recording medium 193 is constituted by a detachable semiconductor memory and the like, is used to record image data, added data, and the like, and data is recorded in or read out from the recording medium 193 via a recording interface (I/F) unit 192. An external interface unit 196 is used to communicate with an external computer 197 or the like. Also, a printer 195 is a printer such as a small inkjet printer, and a captured image is output to the printer 195 via a print interface (I/F) unit 194. Furthermore, the image capturing apparatus 100 is capable of communicating with a computer network 199 such as the Internet via a wireless interface unit 198. A switch input unit 179 includes the switch 154, the switch 155, and a plurality of switches for switching between various modes.

Configuration of Pixel Portion

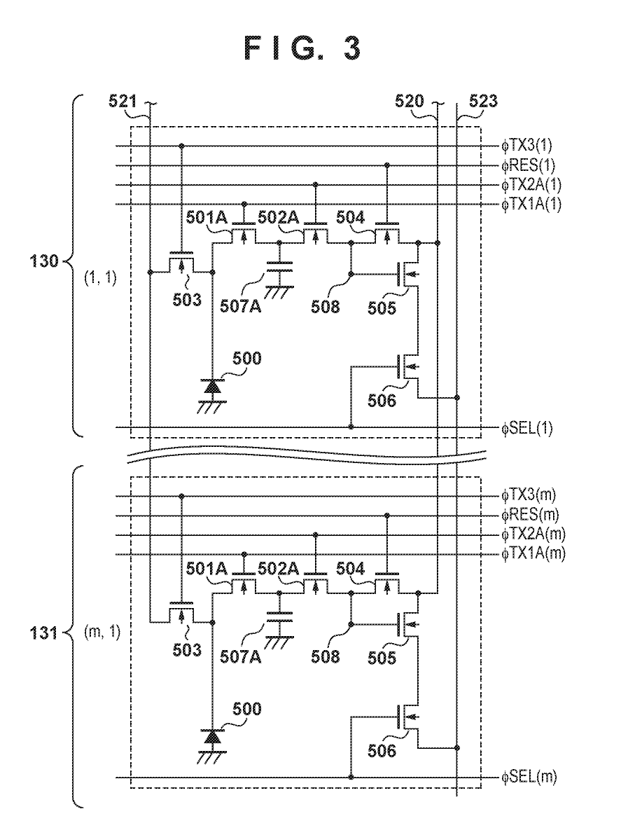

FIG. 3 is a circuit diagram showing portions of the image sensor 184. FIG, 3 shows a pixel 130 in the 1st row and the 1st column (1, 1) and a pixel 131 in the mth row and the 1st column (m, 1) out of multiple pixels of the image sensor 184. Note that the pixel 130 and the pixel 131 have the same configuration, and thus the same constituent elements are given the same reference numerals.

The pixels 130 and 131 each include a photodiode (PD) 500 (photoelectric conversion element), a first transfer transistor 501A, a signal holding unit 507A (accumulation unit), a second transfer transistor 502A, and a third transistor 503. Furthermore, the pixels 130 and 131 each include a floating diffusion (FD) region 508, a reset transistor 504, an amplifier transistor 505, and a selection transistor 506.

The first transfer transistor 501A is controlled by a transfer pulse øTX1A, and the second transfer transistor 502A is controlled by a transfer pulse øTX2A. Also, the reset transistor 504 is controlled by a reset pulse øRES, and the selection transistor 506 is controlled by a selection pulse øSEL. Furthermore, the third transfer transistor 503 is controlled by a transfer pulse øTX3. The control pulses are sent out from a vertical scanning circuit (not shown). Reference numerals 520 and 521 indicate power lines, and reference numeral 523 indicates a signal output line for outputting a signal from the pixels 130 and 131.

Imager ND Function

In this embodiment, the light amount of incident light can be controlled by controlling the timing of charge accumulation in the image sensor 184. Hereinafter, the function of controlling a light amount by controlling the timing of charge accumulation in the image sensor 184 is referred to as an “imager ND function”.

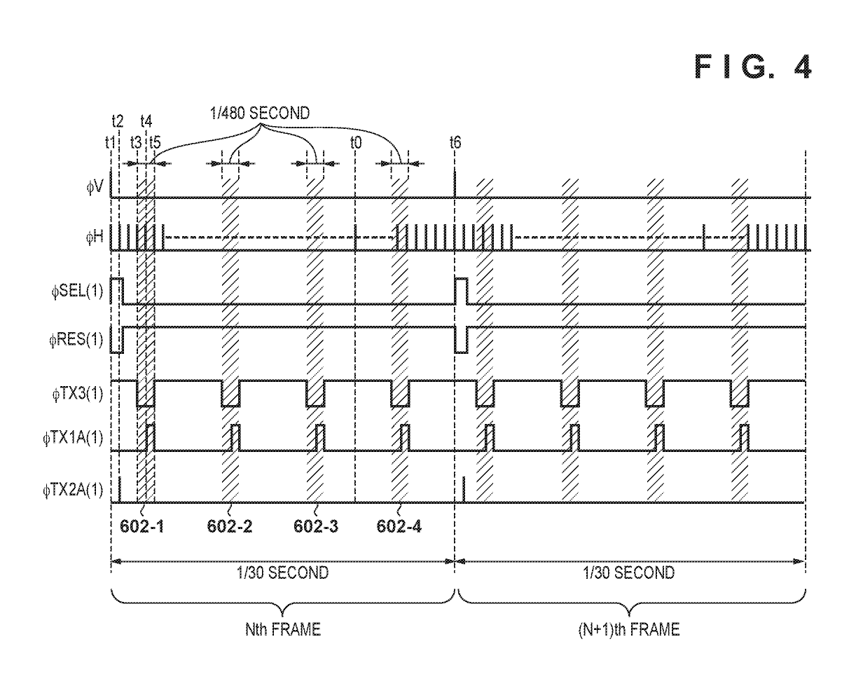

FIG. 4 is a timing chart for illustrating operations when charge accumulation and reading are controlled so as to realize the imager ND function of the image sensor 184, and shows signals for controlling transfer units and reset transistors, and the like. Herein, the case where a moving image is captured at 30 fps and image signals are obtained by adding four instances of accumulation for 1/480 seconds in a period of 1/30 seconds serving as one frame period will be described as an example.

Note that the image sensor 184 includes pixel rows with multiple columns in the vertical direction, and FIG. 4 shows the timing for the 1st row where a subscript (1) added after each signal represents the 1st row. By executing control on this 1st row in order in the vertical direction while sequentially shifting timing using a horizontal synchronization signal, operations for accumulating charges in and reading out from all of the pixels of the image sensor 184 are performed through so-called rolling shutter driving.

In FIG. 4, time t1 and time t6 at which a vertical synchronization signal øV rises each indicate the start of one frame period, and a time period from time t1 to time t6 corresponds to one frame period (1/30 seconds). Also, the case where an exposure amount that is equivalent to one instance of exposure for 1/120 seconds is obtained by adding four instances of accumulation for 1/480 seconds in a period of 1/30 seconds as imaging conditions is shown.

First, at time t1, a horizontal synchronization signal øH becomes a high level at the same time as the vertical synchronization signal øV becomes a high level in the timing generation unit 189. When a reset pulse øRES(1) in the 1st row becomes a low level in synchronization with time tl when the vertical synchronization signal øV and the horizontal synchronization signal øH become a high level, the reset transistor 504 in the 1st row is turned off. Accordingly, a reset state of the FD region 508 is released. Simultaneously, when the selection pulse øSEL(1) in the 1st row becomes a high level, the selection transistor 506 in the 1st row is turned on, and reading out of the image signal in the 1st row is started.

The output according to a change in the potential of the FD region 508 is read out to a signal output line 523 via an amplifier transistor 505 and the selection transistor 506. Then, the output is supplied to a readout circuit (not shown), and is output to an external portion as an image signal (moving image) of the 1st row that has been accumulated in the previous frame.

At time t2, when the transfer pulse øTX2(1) in the 1st row reaches a high level, the second transfer transistor 502A in the 1st row is turned on. At this time, the reset pulse øRES(1) is at a high level and the reset transistor 504 is on, and thus the FD region 508 and the first signal holding unit 507A in the 1st row are reset to the voltage of the power source. Note that the selection pulse øSEL(1) in the 1st row is at a low level at time t2.

At time t3, when the transfer pulse øTX3(1) in the 1st row reaches a low level, the third transfer transistor 503 is turned off, resetting of the PD 500 in the 1st row is cancelled, and accumulation of a signal charge in the PD 500 as a moving image is started. Note that the charge accumulated in the PD 500 is drained via a power line 521 (charge drain region) while the third transfer transistor 503 is on.

At time t4, when the transfer pulse øTX1(1) in the 1st row becomes a high level, the first transfer transistor 501A is turned on, and the charge accumulated in the PD 500 is transferred to the signal holding unit 507A.

At time t5, when the transfer pulse øTX1(1) in the 1st row becomes a low level, the first transfer transistor 501A is turned off, and transfer of the charges accumulated in the PD 500 to the signal holding unit 507A ends.

Herein, a time period from time t3 to time t5 corresponds to one accumulation time period of 1/480 seconds of a moving image in one frame period, and is indicated by a shaded region labeled as an accumulation time period 602-1. Such an accumulation operation is discretely performed four times, and are shown as the shaded regions labeled as accumulation time periods 602-1, 602-2, 602-3, and 602-4. By adding the charges obtained in these four accumulation time periods, the charges obtained in the total of the accumulation time periods (1/480 seconds×4=1/120 seconds) are obtained. Note that control operations in the accumulation time periods 602-2, 602-3, and 602-4 are similar to the accumulation time period 602-1, and thus a description thereof will be omitted.

Next, at time t6, the horizontal synchronization signal øH becomes a high level at the same time as when the vertical synchronization signal øV becomes a high level under the control of the timing generation unit 189, and the next imaging cycle starts. Then, an image signal in the 1st row of an Nth frame obtained by adding the charges obtained in the accumulation time periods 602-1, 602-2, 602-3, and 602-4 during the time period from time t1 to time t6 is output to the digital signal processing unit 187 as an image signal (moving image) at time t6 onward,

Note that from the 2nd row onward, operations are executed in synchronization with a horizontal synchronous vibration off immediately after time t1. That is, charge accumulation in and reading out from each row are successively started during the time period from time tl to time t6.

The exposure amount that is equivalent to one instance of exposure for 1/120 seconds can be obtained by adding four instances of accumulation for 1/480 seconds in one frame period of 1/30 seconds through driving shown in the timing chart as described above. This exposure amount is 1/4 of the exposure amount compared to the case of full exposure for 1/30 seconds, which is a period serving as one frame period. Thus, when this exposure amount is converted to the light attenuation amount of the ND filter, the light attenuation effect of two ND stops in which the total exposure amount is ¼ of that of full exposure is achieved.

Note that, although driving using the timing chart shown in FIG. 4 is an example of achieving the effect of two ND stops, by setting a charge accumulation time period for each instance of charge accumulation as appropriate, it is possible to control the total exposure amount and to optionally adjust the light attenuation effect.

For example, if a charge accumulation and transfer operation is repeated four times in one frame period of 1/30 seconds, a charge accumulation time period that can be set per operation is 1/120 seconds corresponding to 1/4 of 1/30 seconds, which is the maximum length of one frame period. At this time, because exposure for 1/120 seconds is repeated four times and thus exposure for 1/120 is multiplied by 4, the total charge accumulation time period is 1/30 seconds and is equal to 1/30 seconds serving as one frame period. This corresponds to a state in which no light attenuation effect is obtained.

Also, if a charge accumulation and transfer operation is repeated four times during an imaging cycle of 1/30 seconds and the charge accumulation time period per operation is 1/240 seconds, which is half of that in the example shown in FIG. 4, the total charge accumulation time period is 1/60 seconds, which is four times 1/240 seconds. This is ½ of 1/30 seconds serving as one frame period, and thus is ½ of the exposure amount compared to the case of full exposure for 1/30 seconds. That is, the light attenuation effect of one ND stop, which halves the light amount, is obtained.

Similarly, if the charge accumulation time period per operation is 1/960 seconds, the light attenuation effect of 3 ND stops where the exposure amount is ⅛ of that of full exposure is achieved, and if the exposure time period is 1/1,920 seconds per operation, the light attenuation effect of 4 ND stops where the exposure amount is 1/16 of that of full exposure is achieved. Adjusting the charge accumulation time period per operation in this manner makes it possible to adjust the light attenuation amount.

One image signal is obtained by adding image signals corresponding to a plurality of short charge accumulation time periods that are set in a frame period of 1/30 seconds at approximately equal intervals under the above-described control, and thus a high-quality moving image with better frame continuity can be obtained.

Note that, although a description was given assuming the number of instances of charge accumulation is 4 in order to facilitate comprehension of the description, the number of instances of charge accumulation may be 8, 16, 32, 64, or the like, for example, and the present invention is not limited by the number of instances of charge accumulation. However, a high-quality moving image with better frame continuity can be obtained by increasing the number of times charge accumulation is split.

Problems of Imager ND Function During Imaging Under High Illuminance

When a moving image is captured utilizing the imager ND function for obtaining an image signal by performing charge accumulation a plurality of times in one frame period, the charge accumulation time period for each instance of charge accumulation sometimes becomes short in an environment where the illuminance of a subject is high and it is necessary to increase the light attenuation amount in order to optimize the light amount. At this time, with the image capturing apparatus 100 configured to drive and control the image sensor 184 using pulse signals, if the charge accumulation time period is so short that an error of 1 pulse of a pulse signal cannot be ignored, there is a problem in that an error in the total exposure amount increases.

For example, if a moving image is captured at 30 fps, an imaging cycle of one frame is 1/30 seconds. At this time, if the subject has high illuminance and an appropriate exposure amount is achieved by exhibiting a 6 ND stop (light attenuation) effect, an appropriate total charge accumulation time period of one frame is 1/1,920 seconds, which is obtained by dividing 1/30 seconds by 64 (2 to the 6th power). Herein, if charge accumulation is performed 64 times in one frame period in order to obtain a high-quality moving image, an appropriate charge accumulation time period for each instance of charge accumulation of 64 instances of charge accumulation is 1/122,880 seconds, which is obtained by dividing 1/1,920 seconds, which is the total charge accumulation time period in one frame, by 64, which is the number of times charge accumulation is split.

As described above using the timing chart shown in FIG. 4, each charge accumulation timing is controlled by the pulse signals, and if the pulse signal is emitted at 300 kHz, a time period per pulse is 1/300,000 seconds. Charge accumulation is started or ended at timings when corresponding pulses are emitted, and thus the charge accumulation time period is controlled using a pulse driving method with which charge accumulation is performed for several pulses from start to the end. That is, the charge accumulation time period can only be set by an integer multiple of 1/300,000 seconds, which is the minimum units of a time period of each pulse.

If the subject does not have high illuminance and a 2 ND stop effect (1/4) is sufficient, the appropriate one frame total charge accumulation time period is 1/120 seconds, which is obtained by dividing 1/30 seconds by 4. Thus, even if charge accumulation is split into 64 instances of charge accumulation, the total charge accumulation time period is 1/7,680 seconds, and is 39.06 times 1/300,000 seconds. At this time, in integer multiples of 1/300,000 seconds, a time period that is the closest thereto is 39/300,000 seconds serving as the exposure for the time period of 39 pulses, and thus charge accumulation is performed for 39/300,000 seconds. In this case, the charge accumulation time period of 39/300,000 seconds that can be set is shorter by about 0.16% with respect to 1/7680 serving as an appropriate exposure time period, compared to the appropriate exposure time period.

In contrast, if the subject has high illuminance and a 6 stop ND effect is controlled using the charge accumulation time period that is split into 64 charge accumulation time periods with one frame of 1/30 seconds, 1/122,880 seconds serving as an appropriate exposure time period for one split charge accumulation time period is approximately 2.44 times 1/300,000 seconds. At this time, in integer multiples of 1/300,000 seconds, a time period that is the closest thereto is 2/300,000 seconds serving as the exposure for the time period of 2 pulses, and thus charge accumulation is performed for 2/300,000 seconds. However, the charge accumulation time period for 2/300,000 seconds that can be set is shorter (darker) by about 18% of an appropriate amount with respect to 1/122,880 seconds (2.44 times 1/300,000 seconds) serving as an appropriate exposure time period, and there is a problem in that an error occurs in the exposure amount.

Configuration of Light-Amount Control Element

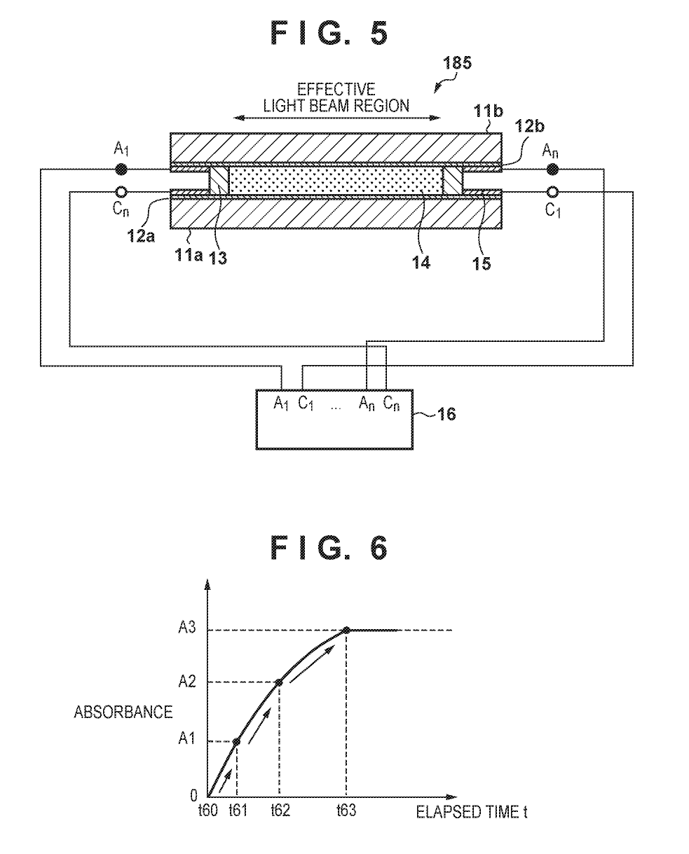

FIG. 5 is a schematic cross-sectional view illustrating the configuration of the light-amount control element 185A, in the present embodiment, it is assumed that the light-amount control element 185A is an ND filter for adjusting the amount of passing light using an electrochromic (EC) material.

The light-amount control element 185A has an electrochromic medium that is located between substrates provided with a pair of transparent electrodes and is constituted by a solvent containing at least one type of electrochromic material, and the pair of transparent electrode substrates are each provided with two or more power supply terminals. A voltage pulse is successively applied from a driving power source to the pair of power supply terminals that are installed at positions that are opposite to each other sandwiching an effective light beam region, in an optical density transition process or an optical density maintaining process.

In FIG. 5, glass substrates 11a and 11b are respectively provided with transparent electrodes 12a and 12b, and the pair of transparent electrode substrates are attached to each other via a seal 13 containing gap control particles (not shown). At this time, a space between the pair of transparent electrode substrates constituted by the glass substrates 11a and 11b and the transparent electrodes 12a and 12b is filled with the electrochromic medium constituted by a solvent containing at least one type of electrochromic material, and forms an organic EC layer 14.

Also, at least two or more power supply terminals A1. A2, . . . . An−1, and An (anodes) and C1, C2, . . . , Cn−1, and Cn (cathodes) (n≥2) are installed in each of the pair of transparent electrode substrates. The power supply terminals are connected to low-resistance wires 15 provided on the transparent electrodes outside of the effective light beam region.

The power supply terminals A1. A2, . . . . An−1, and An and C1, C2, . . . , Cn−1, and Cn (n≥2) are individually connected to the driving power source 16 including drive circuit substrates, and an element is driven by successively applying a voltage pulse, from A1-C1 terminals to An-Cn terminals.

Examples of a method for filling with the organic EC layer 14 include a method for forming a pair of holes in the glass substrates 11a and 11b and filling through the holes and a method for performing vacuum injection through filling holes of a side surface of an organic EC device formed using a seal pattern. Furthermore, a method for filling in vacuum at the same time as attaching the pair of transparent electrode substrates, or the like may also be suitably used.

Optical glass, silica glass, super white glass, glass, borosilicate glass, alkali-free glass, chemically strengthened glass, or the like may be used as the glass substrates 11a and 11b, and in particular, from the view point of transparency and durability, alkali-free glass may be suitably used.

An antireflection layer (not shown) or an index matching layer (not shown) that increases the transmittance of the light-amount control element 185A by reducing reflection of a glass substrate surface, an interface between the glass substrate and the transparent electrode, and an interface between the transparent electrode and the electrochromic medium may be suitably used for the glass substrates 11a and 11b, in addition to the transparent electrodes 12a and 12b,

Also, any material such as plastic or ceramic may be used as appropriate as long as it has transparency. Because the transparent substrate is directly subjected to a force from a change mechanism, a rigid material that is unlikely to warp is preferable. Also, it is more preferable that the substrate has little flexibility. The thickness of the transparent substrate is several tens of μm to several mm.

Tin-doped indium oxide (ITO), zinc oxide, gallium-doped zinc oxide (GZO), aluminum-doped zinc oxide (AZO), tin oxide (NESA), antimony-doped tin oxide (ATO), fluorine-doped tin oxide (PTO), niobium-doped titanium oxide (TNO), and the like, which are so-called transparent conductive oxides, may be used as the material of transparent electrodes 12a and 12b. Also, conductive polymers whose electrical conductivity is increased through doping treatment or the like (for example, polypyrrole, polythiophene, polyacetylene, poly-p-phenylene, or a complex of polyethylene dioxythiophene (PEDOT) and polystyrene sulfonic acid) may also be suitably used. The light-amount control element 185A of the present embodiment preferably has high transmittance in a transparent state, and thus ITO, IZO, and NESA that do not exhibit light absorption in a visible light region, and conductive polymers with high electrical conductivity are preferably used in particular. These may be used in various forms such as bulk, microparticles, or the like. Note that these electrode materials may be used alone or in combination.

Although a thermosetting resin or an ultraviolet curable resin may be used as the seal 13, a suitable material is selected as appropriate by the above-described method for filling with organic EC layer 14, that is, an element production process. Also, it is preferable to mix, in the seal 13, cell gap control particles for defining the gap between the pair of transparent electrode substrates.

The organic EC layer 14 is constituted by one or more types of electrochromic (EC) materials and a solvent, and another useful agent such as a support electrolyte or a viscosity increasing agent may also be added to the organic EC layer 14.

Compounds whose visible light transmittance changes due to oxidation and reduction may be suitably used as the EC material, and of these compounds, organic compounds such as compounds of thiophenes, compounds of phenazines, and compounds of bipyridium salts may be suitably used.

There is no particular limitation on the solvent as long as the EC material and a useful agent such as a support electrolyte are dissolved therein, and a solvent with high polarity may be preferably used, Specific examples include water and organic polar solvents such as methanol, ethanol, propylene carbonate, ethylene carbonate, dimethyl sulfoxide, dimethoxyethane, γ-butyrolactone, γ-valerolactone, sulfolane, dimethylformamide, tetrahydrofuran, acetonitrile, propionitrile, benzonitrile, dimethylacetoamide, methylpyrrolidinone, and dioxolane.

Although there is no limitation on the support electrolyte as long as it is an ionically dissociative salt and has good solubility in the solvent, an electron donative electrolyte is preferably used. Examples thereof include various inorganic ion salts such as alkali metal salts and alkaline earth metal salts, quaternary ammonium salts, and cyclic quaternary ammonium salts. Specific examples include salts of alkali metals such as Li. Na, and K (e.g., LiClO₄, LiSCN, LiBF₄, LiAsF₆, LiCF₃SO₃, LiPF₆, LiI. NaI. NaSCN. NaClO₄. NaBF₄, NaAsF₆, KSCN, and KCl), and quaternary ammonium salts and cyclic quaternary ammonium salts such as (CH₃)₄NBF₄, (C₂H₅)₄NBF₄, (n—C₄H₉)₄NBF₄, (n—C₄H₉)₄NPF₆, (C₂H₅)₄NBr, (C₂H₅)₄NClO₄, and (n—C₄H₉)₄NClO₄.

At least one selected from the group consisting of cyanoethylpolyvinyl alcohol, cyanoethylpullulan, and cyanoethylcellulose may be suitably used as the viscosity increasing agent. These agents are available from Shin-Etsu Chemical Co., Ltd. as CR—V (cyanoethylpolyvinyl alcohol: softening temperature is 20 to 40° C., dielectric constant is 18.9), CR—S (cyanoethylpullulan: softening temperature is 90 to 100° C., dielectric constant is 18.9), CR—C (cyanoethylcellulose: softening temperature is 200° C. or more, dielectric constant is 16). or CR—M (mixture of cyanoethylpullulan and cyanoethylpolyvinyl alcohol: softening temperature is 40 to 70° C., dielectric constant is 18.9), and these agents are additives that solve conflicting problems of high viscosity and high ionic conductivity over a wide temperature range, in a balanced manner.

The organic EC layer 14 is preferably liquid or gel. The organic EC layer 14 is suitably used in a state of the solution constituted by the above compounds, but can be used in a gel state. For gelation, a polymer or a gelling agent is further added to the solution. There is no particular limitation on the polymer (gelling agent), and examples thereof include polyacrylonitrile, carboxylmethylcellulose, polyvinyl chloride, polyvinyl bromide, polyethylene oxide, polypropylene oxide, polyurethane, polyacrylate, polymethacrylate, polyamide, polyacrylamide, polyester, polyvinylidene fluoride, and nafion. In this manner, a viscous compound, gel compound, or the like may be used as the organic EC layer 14.

Also, in addition to use in a mixed state as described above, these solutions may be supported by a structural skeleton (for example, spongiose structural skeleton) that has a transparent and soft network structure.

That is, the light-amount control element 185A of the present invention is an organic electrochromic device (organic EC device) including a pair of electrodes, an electrochromic layer having an electrolyte and an EC material that is provided between the pair of electrodes, and a member disposed between the pair of electrodes.

Also, a method for driving the light-amount control element 185A that is the organic EC device according to the present invention is performed by applying a voltage across both transparent electrodes 12a and 12b connected to the driving power source 16 so as to cause the organic EC material to undergo an electrochemical reaction.

The organic EC material is in a neutral state when no voltage is applied, and does not absorb light in a visible light region. In such a transparent state, the light-amount control element 185A exhibits high transmittance. By applying a. voltage across the transparent electrodes 12a and 12b, an electrochemical reaction occurs in the organic EC material, and the organic EC material takes on an oxidation state or a reduction state from the neutral state. The organic EC material absorbs light in a visible light region in oxidation and reduction states, and is colored. In such a colored state, the transmittance of the light-amount control element 185A decreases.

Even if the light-amount control element 185A has an electrochrornic layer including a plurality of types of EC material, it is possible to express gradation in the intermediate state as appropriate.

Note that this first embodiment is characterized by including the light-amount control element 185A having the above-described configuration and an active element (not shown) connected to the light-amount control element 185A. In the present embodiment, examples of the active element include a transistor and an MIM device. The transistor includes, as an active layer, single crystal silicon, non-single crystal silicon such as amorphous silicon or microcrystal silicon, and a non-single crystal oxide semiconductor such as indium zinc oxide or indium gallium zinc oxide. The transistor may be a thin film transistor. The thin film transistor is also referred to as a TFT device.

Problems of Operation of Light-Amount Control Element in Which EC Material is Used

As described above, the EC material used in the light-amount control element 185A utilizes the fact that the light beam absorptivity of EC molecules changes according to the characteristics of the EC molecules when an oxidation-reduction reaction occurs in response to the application of a voltage to EC molecules. While it depends on the applied voltage, the ambient temperature, the composition of the EC molecule, and the like, the oxidation-reduction reaction needs a predetermined reaction time, and thus a stabilization period for the light-amount control element 185A is defined.

FIG. 6 is a graph showing the relationship between the lapse of time from when a predetermined voltage is applied to the light-amount control element 185A and the absorbance (light attenuation amount) indicating the light beam absorptivity of the light-amount control element 185A. When a voltage is applied, the absorbance simply increases as time passes, and the absorbance changes from A1, through A2, to A3 while increasing from time t61 to time t63. At this time, the slope of the graph is a curve whose slope is at its largest at the beginning and decreases over time, and that draws an arc convex to the upper left. From the graph shown in FIG. 6, it can be seen that the higher the obtained absorbance is, the longer the stabilization period required for the oxidation-reduction reaction to proceed to reach a desired absorbance is.

That is, electrically driving the organic EC layer 14 in the EC material requires the predetermined stabilization period until coloring or decoloring according to the reaction time of the oxidation-reduction reaction is complete, and involves a predetermined delay time in response to an instruction from a user or a camera. This causes problems such as a delay in the ND function in response to a rapid change in luminance. Also, the higher the obtained light attenuation amount (the number of ND stops) is, the longer the delay time is.

Control Method

As described above, in a high-illuminance environment, the imager ND function of the image sensor 184 leads to the issue of exposure amount adjustment errors, whereas the light-amount control element 185A leads to the problem of the delay until a desired absorbance is achieved. In view of this, in the present embodiment, the problems are alleviated by using both the imager ND function and the light-amount control element 185A.

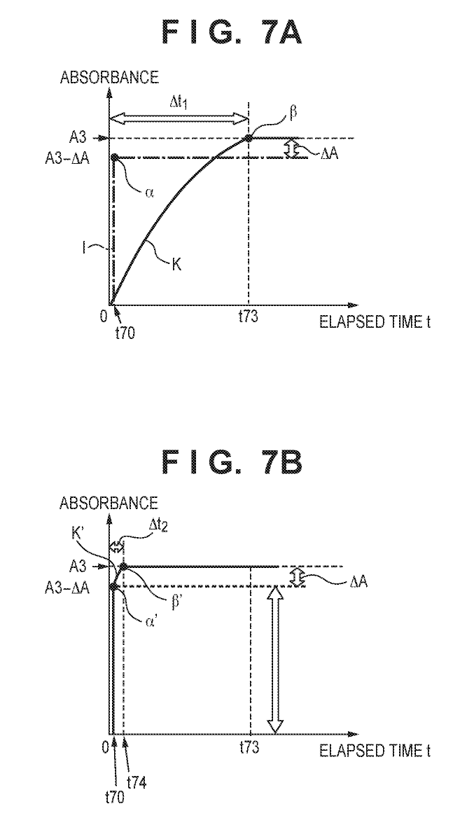

FIG. 7A is a diagram showing the relationship between the absorbance (light attenuation amount) and the stabilization period in the case of using a conventional method in which the absorbance is adjusted by controlling the imager ND function alone or the light-amount control element 185A alone.

In FIG. 7A, a curve K indicated by a solid line shows a case where the absorbance is adjusted using the light-amount control element 185A alone, and indicates a monotonical increase from the start point where the absorbance is 0 toward a target absorbance A3 along the curve K. Although the absorbance arrives at the target absorbance A3 at a point β without error, the amount of time that has passed starting from the absorbance 0 to A3 is indicated by t73, and it takes a long stabilization period (Δt₁) from the start for the absorbance to arrive at the target value. As described above, this stabilization period Δt₁ has a characteristic in which as the amount of the change in the absorbance increases, the stabilization period increases. That is, with the light-amount control element 185A including the EC material, fine absorbance adjustment is possible without error, but if the light amount of incident light is greatly reduced (if the amount of the change in the absorbance is large), as the light attenuation amount increases, the stabilization period increases.

Also, a line I indicated by a dot-dash line in FIG. 7A shows a case where the exposure amount (converted to absorbance) is adjusted by the imager ND function of the image sensor 184 alone. The absorbance arrives, at time t70, at a value (target absorbance A3-ΔA) that is indicated by a point αand is closest to the target value out of the absorbances that can be set, through a small response time from the start where the absorbance is 0. The stabilization period for the imager ND function is a brief time period required to switch the exposure time period of the image sensor 184, which is required to switch an electronic device. Thus, compared to the stabilization period resulting from the EC material of the light-amount control element 185A, the stabilization period for the imager ND function may be regarded as approximately 0.

However, as described above, if the illuminance of the imaging environment is high and a large light attenuation amount is required, as shown in FIG. 7A, there is a problem in that a large absorbance error AA from the target absorbance A3 occurs. That is, with the imager ND function alone, the absorbance can be adjusted at a high speed with a short response time, but if the light attenuation amount is large, a large error ΔA occurs and fine light amount adjustment is not possible.

In contrast, FIG. 7B shows a graph when the absorbance is adjusted using both the imager ND function and the light-amount control element 185A in this first embodiment. The imager ND function is utilized from the start point where the absorbance is 0, at time t70, the absorbance is adjusted until the absorbance reaches a value (A3-ΔA) that is indicated by a point α′ at which the absorbance (light attenuation amount) is smaller than the target value, and that is closest to the target value out of the absorbances that can be set by the imager ND function. Then, control is performed such that the absorbance is adjusted using the light-amount control element 185A by the amount of the absorbance error ΔA occurring at this time, so as to arrive at the target absorbance A3 indicated by a point β′ without error at time t74.

It can be seen that at this time, time t74 shown in FIG. 7B when the absorbance arrives at the target absorbance under the control in the first embodiment is significantly earlier than time t73 shown in FIG. 7A when the absorbance arrives at the target absorbance using the light-amount control element 185A alone (Δt₂). Also, it can be seen that the error ΔA occurs with respect to the target absorbance in the above-described absorbance adjustment using the imager ND function alone, whereas the control shown in FIG. 7B can eliminate the absorbance error.

In this manner, in the first embodiment, for the light-amount control element 185A whose response time increases as the light attenuation amount increases, most of the amount of a change in the absorbance up to the target value is handled by the imager ND function whose response time is short. Thus, the width of a change in the absorbance handled by the light-amount control element 185A is reduced. Accordingly, compared to the case where all of the light attenuation amount is handled by the light-amount control element 185A alone, the light attenuation amount covered thereby are significantly reduced, and accordingly, the response time can be significantly shortened. Also, fine light amount adjustment that cannot be achieved by the imager ND function alone can be performed by using the light-amount control element 185A in combination therewith as described above.

Herein, an example of controlling the imager ND function and the light-amount control element 185A under the control shown in FIG. 7B will be described below. Herein, it is assumed that light attenuation with a large ratio in a high-illuminance environment is required and an appropriate charge accumulation time period for each instance of charge accumulation using the imager ND function is 1/200,000 seconds (=3/600,000 seconds). Also, it is assumed that the pulse cycle of the image capturing apparatus 100 that is driven by pulses is 300 kHz, that is, the minimum unit set for the charge accumulation time period is 1/300,000 seconds. In this case, 2/300,000 seconds (=4/600,000 seconds), which is twice the minimum unit, can be set as the charge accumulation time period for each instance of charge accumulation using the imager ND function, resulting in a charge accumulation time period with which the exposure amount allows for more brightness than an appropriate exposure amount (target exposure amount or more) and that is closest to the target value. Exposure performed in this case for 2/300,000 seconds (=4/600,000 seconds) results in charge accumulation for 4/3 times an appropriate exposure amount 1/200,000 seconds (=3/600,000 seconds), which results in an excessive exposure amount.

In a situation in which an excessive exposure amount by 4/3 fold due to light attenuation using the imager ND function in this manner is presumed, before the luminous flux is incident on the image sensor 184, the incident light is attenuated to be 3/4 times the light amount, 3/4 being the inverse of 4/3, using the light-amount control element 185A and an error in the exposure amount is corrected. Specifically, a predetermined voltage is applied to the light-amount control element 185A so as to be colored, and the absorbance is adjusted. such that the amount of light after transmission is 3/4 times the incident light.

As described above, light is attenuated using the imager ND function while the luminous flux that was corrected (the light amount is corrected to 3/4 folds) by the light-amount control element 185A is incident on the image sensor 184, and thus an appropriate exposure amount can be obtained.

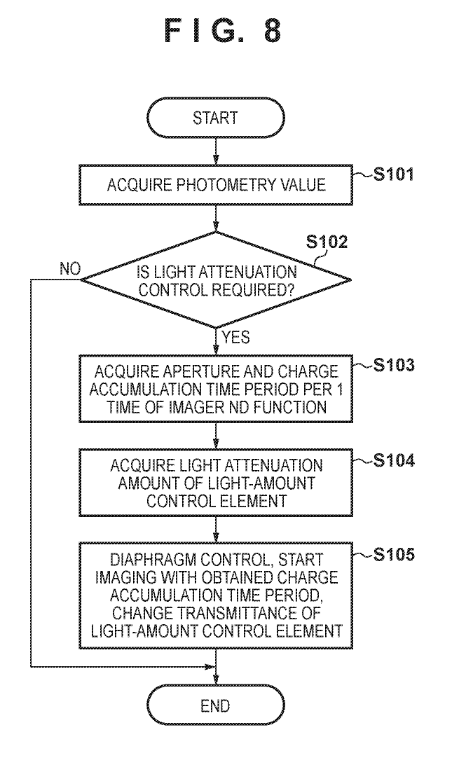

FIG. 8 is a flowchart showing the procedure for controlling the light attenuation amount using the driving method described with reference to FIG. 7B. Note that the processing shown in FIG. 8 is performed repeatedly at predetermined timings while a moving image is being captured or when a still image is captured. First, the system control CPU 178 acquires a photometry value from the photometry unit 170 in step S101. The system control CPU 178 then determines in step S102 whether light attenuation control using the imager ND function and the light-amount control element 185A is required, based on the acquired photometry value. Herein, for example, if the obtained photometry value is a predetermined value or more, it is determined that the light attenuation control is required. Note that if the aperture to be set to the diaphragm 181 is predetermined, for example, if imaging needs to be performed at a designated depth of field, the photometry value is compared to a predetermined value that has been set according to the aperture. As a result of the determination, if light attenuation control is not required, the processing ends.

On the other hand, if it is determined that light attenuation control is required, first, in step S103, the aperture and the charge accumulation time period for each instance of charge accumulation of a plurality of charge accumulation time periods in each frame using the imager ND function are acquired according to the photometry value. Then, in step S104, the light attenuation amount of the light-amount control element 185A is acquired according to an excessive exposure amount using the imager ND function. In this manner, when the photometry value, the aperture, and the charge accumulation time period for each instance of charge accumulation are determined, the light attenuation amount of the light-amount control element 185A is determined as a value according to these values. Thus, it is advisable to store, in the memory unit 190 in advance, a table in which the light attenuation amount (charge accumulation time period for each instance of charge accumulation) using the imager ND function according to the photometry values and the apertures and the light attenuation amount (stored as applied voltages) of the light-amount control element 185A are set. As a matter of course, these values may be obtained through calculations performed by the system control CPU 178 each time.

Then, in step S105, while the diaphragm 181 is controlled using the aperture acquired in step S103 and imaging is started by the image sensor 184 with the charge accumulation time period acquired in step S103, the voltage applied to the light-amount control element 185A is controlled to control the transmittance.

As described above, according to the first embodiment, using both the imager ND function and the variable light attenuation element enables fine light amount adjustment with good responsiveness, regardless of the imaging scene.

### Second Embodiment

Next, a second embodiment of the present invention will be described. Although the EC material is used as the light-amount control element 185A in the above-described first embodiment, an electric light-amount control element in which guest-host liquid crystal containing a dichroic dye is used may also be used.

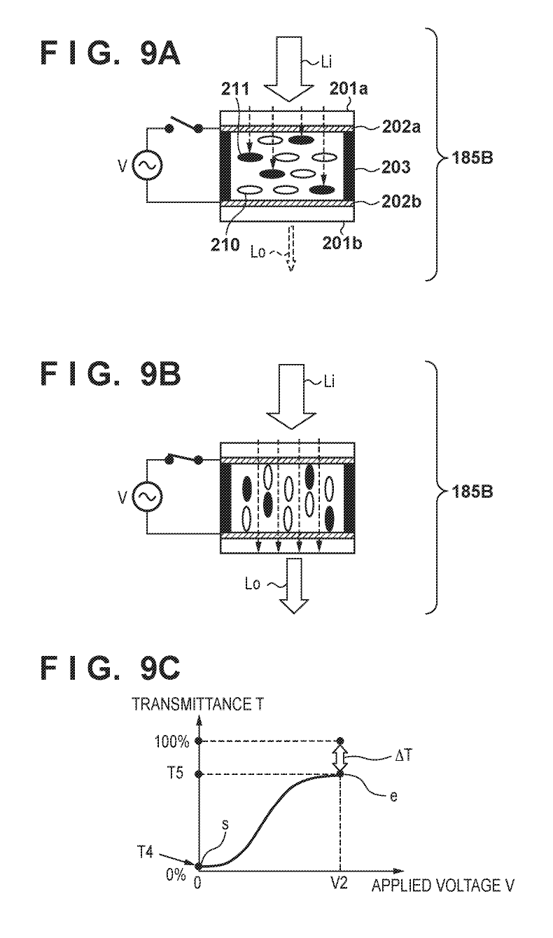

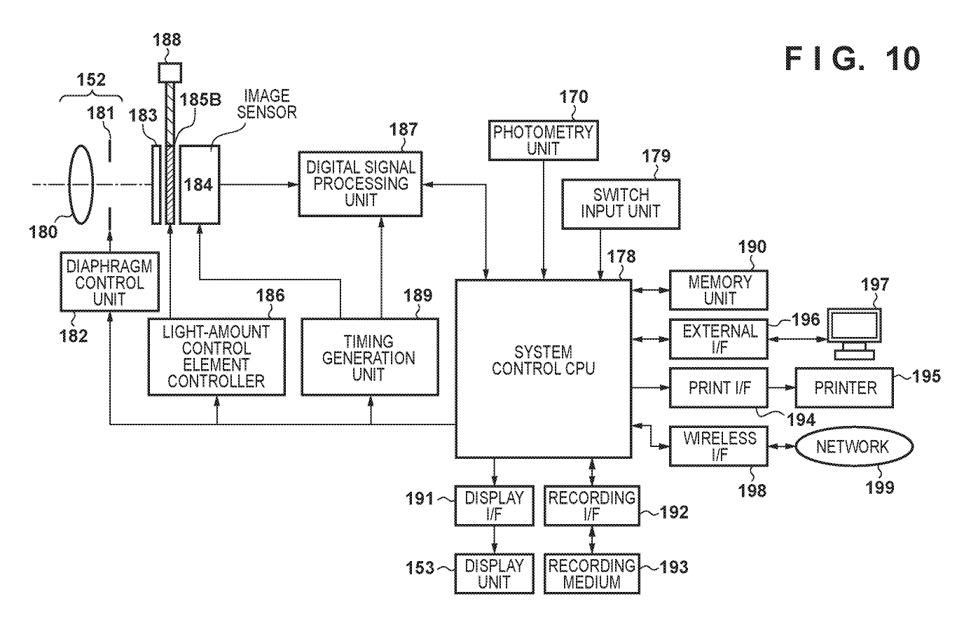

FIGS. 9A to 9C are schematic cross-sectional views of an electric light-amount control element 185B in which guest-host liquid crystal containing the above-described dichroic dye is used. The light-amount control element 185B has a configuration in which a space between a transparent substrate 201a and a transparent substrate 201b that are disposed facing to each other is filled with a mixture obtained by mixing liquid crystal molecules 210 and a dichroic dye 211 together, and its surrounding is sealed by a sealing material 203. Inner surfaces of the transparent substrates 201a and 201b in the sealed space are respectively provided with a transparent electrode 202a and a transparent electrode 202b, and the light-amount control element 185B has a configuration in which a driving voltage V is applied to the liquid crystal molecules 210 and the dichroic dye 211 through these electrodes from the outside.

As shown in FIGS. 9A to 9C, the liquid crystal molecules 210 (hosts) with which the above-described sealed space is filled have a rod shape. Also, the liquid crystal molecules 210 and molecules of the dichroic dye 211 (guest) that similarly have a rod shape are mixed in the sealed space. At this time, molecules of the dichroic dye 211 serving as the guest are oriented in the same direction along the liquid crystal molecules 210 serving as hosts. Herein, the liquid crystal molecules 210 (hosts) have the property of changing orientation when a voltage is applied thereto, and the orientation of molecules of the dichroic dye 211 (guest) also changes to match the orientation of the liquid crystal molecules 210.

FIG. 9A is a diagram showing a state in which no driving voltage V is applied, and the longitudinal direction of the liquid crystal molecules 210 and molecules of the dichroic dye 211 are oriented in the horizontal direction on the paper on which FIG. 9A is illustrated. Also, FIG. 9B shows the state when the driving voltage V is applied across the transparent electrodes 202a and 202b, and the orientation of the liquid crystal molecules 210 change and change to a state in which their longitudinal direction is oriented in the vertical direction on the paper on which FIG. 9B is illustrated, and the orientation of molecules of the dichroic dye 211 also change in the same direction to match the orientation of the liquid crystal molecules 210. Herein, the dichroic dye 211 has a property in which its transmittance changes due to the orientation of rod-shaped molecules with respect to the incident light. Thus, when the driving voltage V is applied to the device as described above and the orientation of molecules of the dichroic dye 211 changes, the transmittance of the light-amount control element 185B can be changed.

FIG, 9C is a graph expressing a change in the transmittance with respect to the applied voltage. FIG. 9C expresses a situation in which as the voltage increases from the state in which the applied driving voltage is 0, the transmittance monotonically increases while drawing a nonlinear curve. Herein, a point s indicates the state in which the driving voltage V is not applied (voltage is 0), and the transmittance is at its lowest value T4. At this time, as shown in FIG. 9A, the liquid crystal molecules 210 and molecules of the dichroic dye 211 are in an oriented state in which the longitudinal direction of the molecules is oriented in a direction perpendicular to the direction in which incident light Li travels. Also, a point e shown in FIG. 9C indicates the state in which a driving voltage V2 is applied, and the transmittance is at its maximum value T5. At this time, as shown in FIG. 9B, the liquid crystal molecules 210 and molecules of the dichroic dye 211 are in a state in which the longitudinal direction of the molecules is oriented parallel to the direction in which the incident light Li travels.

FIG. 10 is a block diagram showing a schematic functional configuration of an image capturing apparatus 200 in the second embodiment. The image capturing apparatus 200 shown in FIG. 10 is different from the image capturing apparatus 100 shown in FIG. 2 described in the first embodiment in that the image capturing apparatus 200 does not include the light-amount control element 185A, and a light-amount control element 185B having the configuration shown in FIGS. 9A to 9C and a retraction actuator 188 are added. The configurations other than the above are similar to those shown in FIG. 2, and thus the same configurations are given the same reference numerals and a description thereof is omitted.

Note that a light-amount control element controller 186 in this second embodiment applies a driving voltage to the above-described liquid crystal molecules 210 and dichroic dye 211 included in the light-amount control element 185B. Applying the driving voltage causes a change in the transmittance and controls the light attenuation amount of the luminous flux that passes through the light-amount control element 185B.

Problems of Operation of Light-Amount Control Element in Which Liquid Crystal Light Control Element is Used

Because liquid crystal molecules have low transmittance in the guest-host liquid crystal in which the dichroic dye is used, as expressed by the point e shown in FIG. 9C, a ratio ΔT at which outgoing light Lo is attenuated with respect to the incident light Li is high (transmittance T5) even in the maximum transmittance state. Thus, adjustment is possible only between transmittance T4 and transmittance T5, and adjustment cannot be realized in a state in which light has passed through the above-described liquid crystal in a range where the transmittance is greater than T5. Thus, the case where the light attenuation amount required for the target exposure amount is low and a transmittance that exceeds T5 is required is handled by a configuration in which the light-amount control element 185B is retracted by an actuator from the front of the image sensor 184. However, in this case, the transmittance of the image capturing apparatus 200 is adjusted only by two levels of the state in which the light-amount control element 185B is in front of the image sensor 184 (transmittance T5) and the state in which it is retracted (transmittance 100%). Thus, there is a problem in that the light amount cannot be adjusted in a range where the transmittance is higher than T5 and below 100% which is the range between these states.

In the second embodiment, the problem that fine light amount adjustment cannot be performed under low illuminance as described above is solved by using the imager ND function in combination as described above.

Control Method

As shown in FIG. 10, the light-amount control element 185B is disposed in front of the image sensor 184 and the luminous flux that has passed therethrough and whose light amount is adjusted is incident on the image sensor 184 in the image capturing apparatus 200 in the second embodiment. The light-amount control element 185B can be retracted from the position in front of the image sensor 184 using the retraction actuator 188. Also, the light-amount control element controller 186 transmits a signal to the retraction actuator 188 depending on the illuminance of an object to be imaged, and controls advancing or retracting of the light-amount control element 185B.

In the present embodiment, the light-amount control element 185B is kept disposed in front of the image sensor 184 without being retracted in imaging with a high light attenuation amount required for the target exposure amount under high illuminance, and the light-amount control element 185B is caused to function. Then, similarly to the above-described first embodiment, the light amount of the incident luminous flux is adjusted in combination with the imager ND function.

Also, when the illuminance is not that high and the light attenuation amount required for the target exposure amount is small, the retraction actuator 188 operates in response to receiving a signal transmitted from the light-amount control element controller 186 so as to retract the light-amount control element 185B from the position in front of the image sensor 184. By doing this, the luminous flux from the outside is incident on the image sensor 184 without passing through the light-amount control element 185B. Also, charge accumulation is performed on the incident luminous flux a plurality of times, and at this time, the light amount is adjusted using the imager ND function for adjusting the charge accumulation time period. In this manner, the light amount is adjusted under low illuminance only using the imager ND function.

As described above, the imager ND function leads to a large error in the light amount when the light attenuation amount required for the target exposure amount is high under high illwninance, but can perform fine light amount adjustment in other situations. Conversely, the light-amount control element 185B in which a liquid crystal element is used can perform fine light amount adjustment under high illuminance, but when the illuminance is not that high and the light attenuation amount required for the target exposure amount is small, the maximum transmittance is not 100%, and thus cannot perform fine light amount adjustment.

Thus, the light amount is adjusted in imaging when the light attenuation amount required for the target exposure amount tinder high illuminance is high, using both the imager ND function and the light-amount control element 185B. On the other hand, the light amount is adjusted only using the imager ND function in imaging when the illuminance is not that high and the light attenuation amount required for the target exposure amount is low. This covers ranges that are weakpoints therefor and enables fine light amount adjustment in any illuminance environment.

According to the second embodiment as described above, even if liquid crystal is used as the light-amount control element 185B, effects that are similar to those of the first embodiment can be obtained.

### Third Embodiment

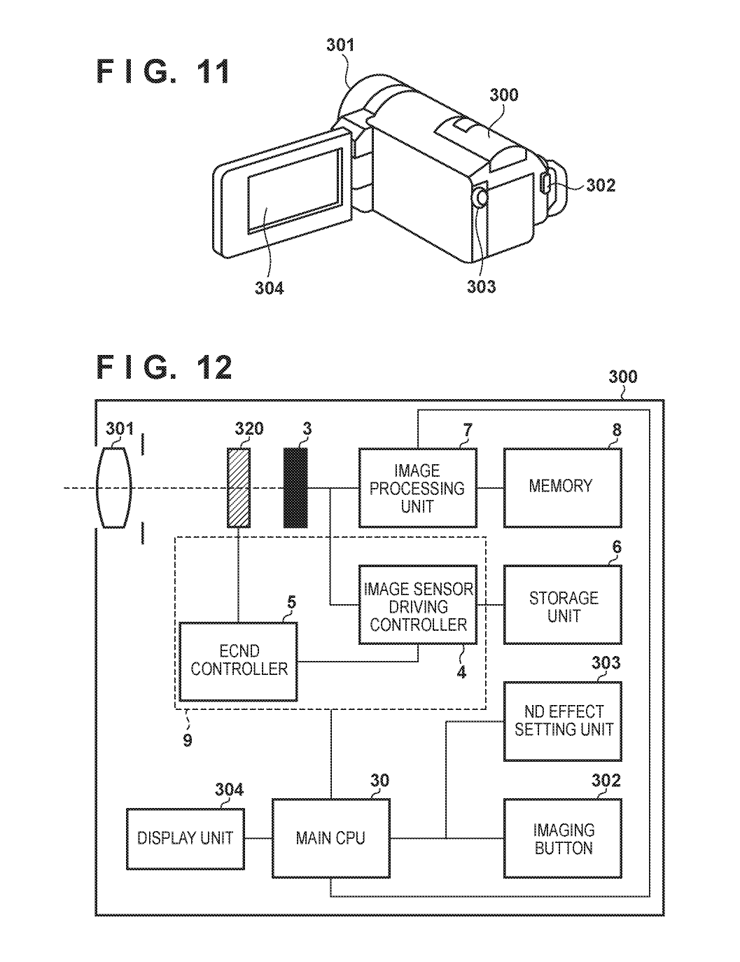

Next, a third embodiment of the present invention will be described. FIG. 11 is an external view of an image capturing apparatus 300 in the third embodiment. In FIG. 11, an exterior portion of the image capturing apparatus 300 is provided with an imaging button 302 that is an operation member for starting and stopping imaging, and an ND effect setting unit 303 that is an operation member for adjusting the exposure amount of the luminous flux for imaging a subject that is incident from an imaging optical system 301 at the time of imaging. A user can set the exposure amount of the luminous flux imaging a subject by operating the ND effect setting unit 303 so as to cause a light-amount control element, which will be described later, to function. Also, the image capturing apparatus 300 is provided with a display unit 304 that displays an image of the subject and imaging conditions at the time of imaging. As will be described later, an imaging preview image or a captured image during imaging that has undergone development processing in an image processing unit 7 is displayed on the display unit 304.

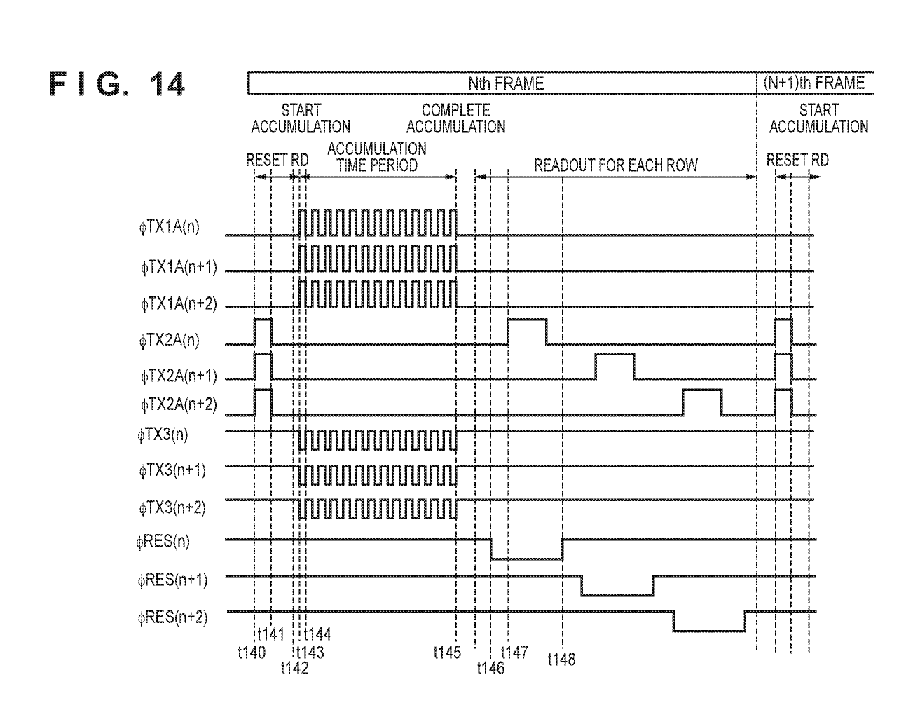

FIG. 12 is a block diagram showing a schematic functional configuration of the image capturing apparatus 300 in the third embodiment of the present invention. The imaging luminous flux passes through the imaging optical system 301 and forms an image on an image sensor 3. Although the details will be described later, similarly to the image sensor 184 in the above-described first embodiment, the image sensor 3 has an imager ND function and is capable of adjusting the exposure amount by controlling the accumulation time period and the number of times accumulation is performed. Note that a method for driving the image sensor 3 for realizing the imager ND function in the third embodiment will be described later with reference to FIG. 14. An image sensor driving controller 4 carries out the adjustment of the exposure amount using the image sensor 3.

A light-amount control element 320 is arranged between the imaging optical system 301 and the image sensor 3. Note that the light-amount control element 320 has a configuration that is similar to that of the light-amount control element 185A described with reference to FIG. 3, and thus a description thereof is omitted. The light-amount control element 320 is capable of adjusting the exposure amount of the imaging luminous flux that forms an image on the image sensor 3 by driving and controlling coloring of an EC material incorporated in the light-amount control element 320. An ECND controller 5 controls the exposure amount using the light-amount control element 320. The image sensor driving controller 4 that controls the adjustment of the exposure amount using the image sensor 3 and the ECND controller 5 that controls the adjustment of the exposure amount of the light-amount control element 320 constitute an ND control unit 9 configured to control both of them. Although the ND control unit 9 is arranged separately from a main CPU 30 (described later) in the image capturing apparatus 300 in the third embodiment, the present invention is not limited thereto, and the ND control unit 9 may also be arranged inside the ain CPU 30. Also, the ND control unit 9 may also be arranged as at least one unit component of each of the image sensor 3 and the light-amount control element 320.

The image sensor driving controller 4 controls the imager ND function of the image sensor 3 based on the detection result of an EC coloring detection unit (not shown) configured to detect a colored state of the EC material of the light-amount control element 320 and characteristic values of the light-amount control element 320 stored in a storage unit 6 of the image capturing apparatus 300. The imaging luminous flux that has formed an image on the image sensor 3 is photoelectrically converted into an image signal, subjected to development processing in the image processing unit 7, and stored in a memory 8.

The main CPU 30 is a central processing unit configured to perform various control of the entire image capturing apparatus 300. The main CPU 30 is capable of detecting that the imaging button 302 or the ND effect setting unit 303 has been operated. The main CPU 30 performs an imaging operation of the image capturing apparatus 300 when the imaging button 302 is operated, records the imaging luminous flux that forms an image on the image sensor 3, and stops the imaging operation.

Also, when the ND effect setting unit 303 is operated, the main CPU 30 detects an operation amount and an operation speed of the ND effect setting unit 303 via a rotary encoder (not shown), for example. Then, the main CPU 30 calculates the number of ND effect stops that is set by the user from the detected operation amount. That is, the main CPU 30 increases the number of ND effect stops if the operation amount of the ND effect setting unit 303 is large, and reduces the number of ND effect stops if the operation amount is small, and thereby adjusts the exposure amount using the imager ND function or the light-amount control element 320 via the ND control unit 9. Also, the main CPU 30 calculates the rate of change in the number of ND effect stops that is desired by the user, from the detected operation speed. That is, the main CPU 30 adjusts the exposure amount using the imager ND function and/or the light-amount control element 320 via the ND control unit 9 so as to increase the rate of change in the number of ND effect stops when the operation speed of the ND effect setting unit 303 is high, and reduce the rate of change in the number of ND effect stops when the operation speed is low.

Configuration of Pixel Portion

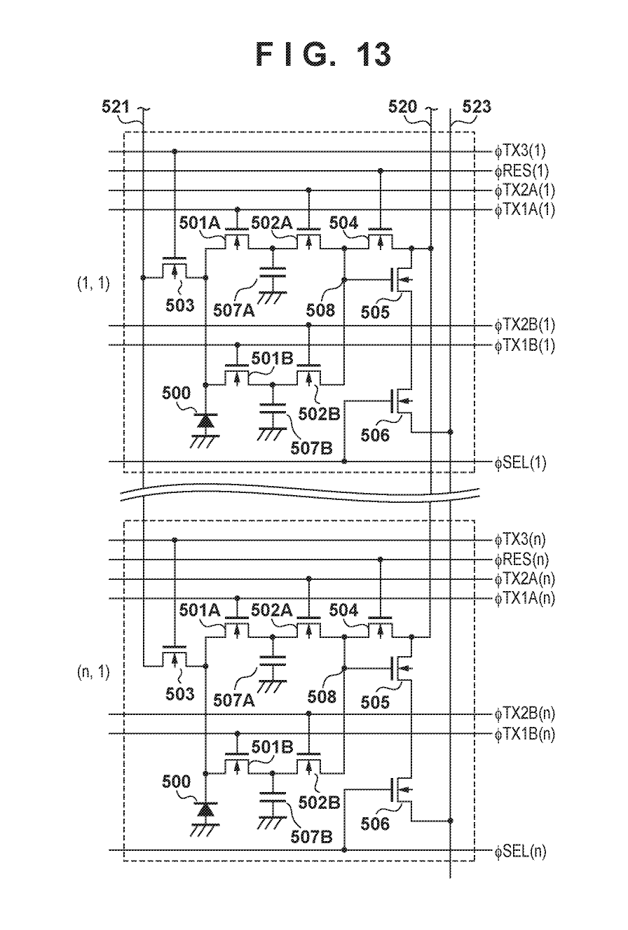

FIG. 13 is a circuit diagram showing portions of the image sensor 3. The image sensor 3 is of a CMOS-type, and FIG. 13 shows a pixel in the 1st row and the 1st column (1, 1) and a pixel in the nth row and the 1st column (n, 1) that is the final row, out of multiple pixels of the image sensor 3. Elements of the pixel in the 1st row and the 1st column (1, 1) and the configuration of the pixel in the nth row and the 1st column (n, 1) are similar to each other, and thus the same constituent elements are given the same reference numerals.

Each of the pixels of the image sensor 3 is different from those of the first embodiment in that they include a fourth transfer transistor 501B, a second signal holding unit 507B, and a fifth transfer transistor 502B, in addition to the configuration of the image sensor 184 described in the first embodiment with reference to FIG. 3. The constituent elements other than the above are similar to those shown in FIG. 3, and thus are given the same reference numerals and a description thereof will be omitted. The fourth transfer transistor 501B is controlled by a transfer pulse øTX1B, and the fifth transfer transistor 502B is controlled by a transfer pulse øTX2B. Also, in order to distinguish from the second signal holding unit 507B, the signal holding unit 507A is referred to as “first signal holding unit 507A” in the description below.

As shown in FIG, 13, each of the pixels of the image sensor 3 in the present invention has two first and second signal holding units 507A and 507B with respect to one PD 500. The basic structure of such a CMOS image sensor 3 having two signal holding units is disclosed in Japanese Patent Laid-Open No. 2013-172210 by this applicant, and thus a description thereof will be omitted.

The image sensor 3 in the third embodiment has the two first and second signal holding units 507A and 507B with respect to the one PD 500, and thus, is capable of capturing a still image and a moving image at the same time, for example. Also, although a detailed sequence will be described later, a charge is transferred from the PD 500 to the two signal holding units 507A and 507B via the first and fourth transfer transistors 501A and 501B. At this time, the total accumulation time period in each frame can be adjusted according to the width of transfer pulses and the number of transfer pulses of the first and fourth transfer transistors 501A and 501B. That is, the imager ND function of the image sensor 3 is realized by adjusting this total accumulation time period.

Note that, although the image sensor provided with the two signal holding units is described as one example in the third embodiment, the present invention is not limited to this as long as the image sensor has the imager ND function.

Imager ND Function

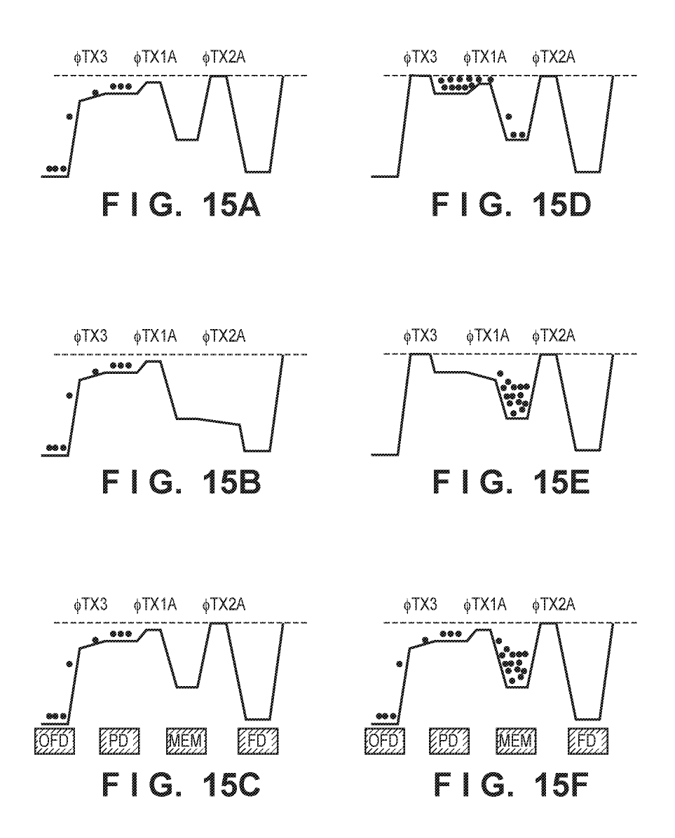

Next, the imager ND function carried out by the image sensor 3 will be described with reference to FIGS. 14 and 15A to 15F. In the third embodiment, a drive control for realizing the imager ND function by splitting a designated exposure time period into a plurality of periods and intermittently performing charge accumulation at predetermined intervals, and collectively reading o charges obtained in a plurality of charge accumulation time periods will be described. Note that, with respect to the so-called rolling shutter control described with reference to FIG. 4, in the third embodiment, in-plane synchronous electronic shutter operation is performed by which imaging is performed at the same timing for all pixels by transferring charges in all of the pixels to an FD region 508 at the same time.

FIG. 14 is a timing chart illustrating operations when charge accumulation and reading are controlled so as to realize the imager ND function of the image sensor 3, and shows signals for controlling transfer units and reset transistors. FIGS. 15A to 15F are diagrams showing potential states of pixels at each timing from immediately before time 1140 to the end of the accumulation time period, out of the timings shown in FIG. 14. Note that in order to facilitate the description herein, a case where charge accumulation and transfer to the signal holding units are performed using the PD 500, the first transfer transistor 501A, the first signal holding unit 507A , and the second transfer transistor 502A will be described. Furthermore, operations up to when readout is performed are carried out using the third transfer transistor 503, the FD region 508, the reset transistor 504, the amplifier transistor 505, and the selection transistor 506. Note that similar driving may also be performed using the fourth transfer transistor 501B, the second signal holding unit 507B, and the fifth transfer transistor 5023, instead of the first transfer transistor 501A, the first signal holding unit 507A, and the second transfer transistor 502A.

FIG. 14 shows changes in pulses øTX1A to øTX3 that are provided to control electrodes of the transfer transistors 501A, 502A, and 503, and changes in a pulse øRES that is provided to a control electrode of the reset transistor 504. Subscripts (n), (n+1), and (n+2) added after signals represent the row number in an image capturing region of the image sensor 3. and for example, øTXIA(n) means a pulse that is provided to the first transfer transistor 501A of the pixel in the nth row.

First, in the initial state before time t140, the pulse øTX1A and the pulse øTX2A are at a low level, and the pulse øTX3 and the pulse øRES are at a high level. The potential state of the pixel at this time is shown in FIG. 15A. In this period, a potential barrier is formed in the first transfer transistor 501A (øTX1A) against the first signal holding unit 507A. On the other hand, the third transfer transistor 503 (øTX3) has no potential barrier. Thus, the charges (black circles in FIG. 15A) generated in the PD 500 (PD) are drained to an overflow drain (OFD) (charge drain region) via the third transfer transistor 503 (øTX3) without moving to the first signal holding unit 507A (MEM). Herein, the potential barrier formed in the first transfer transistor 501A (øTX1A) is lower than the potential barrier formed in the second transistor 502A (øTX2A). The reason for doing this is because an example in which the transistor constituted by the PD 500, the first transfer transistor 501A (øTX1A), and the first signal holding unit 507A (MEM) are considered as being of an embedded-channel type.

The pulse øTX2A(n) to øTX2A(n+2) are at a high level in a period from time t140 to time t141. Thus, the potential barrier that is formed in the second transfer transistor 502A (øTX2A) between the first signal holding unit 507A (MEM) and the FD region 508 is eliminated. Accordingly, the charge held by the first signal holding unit 507A (MEM) before tune t140 is reached is transferred to the FD region 508. The potential state of the pixel in this period is shown in FIG. 15B. The pulses øTX1A(n) to øTX1A(n+2) are at a low level, and pulses øTX3(n) to øTX3(n+2) are at a high level in this period, and thus the charge generated in the PD 500 is discharged to the OFD via the third transfer transistor 503 (TX3). Thus, the charge generated in the PD 500 is not ideally present in the first signal holding unit 507A (MEM) at this point in time.

When the pulses øTX2A(n) to øTX2A(n+2) reach a low level at time t141, the potential state of the pixel is as that shown in FIG. 15C. This state is similar to the state shown in FIG. 15A. In this period, the potential barrier formed in the first transfer transistor 501A (øTX1A) is present, whereas the third transfer transistor 503 (øTX3) has no potential barrier. Thus, the charge generated in the PD 500 is drained to the OFD via the third transfer transistor 503 (øTX3) without moving to the first signal holding unit 507A (MEM).

Next, when the pulses øTX3(n) to øTX3(n+2) change to a low level at time t143, the potential state of the pixel is as that shown in FIG. 1517. In this period, the potential barrier formed against the charge accumulated in the first signal holding unit 507A (MEM) of the third transfer transistor 503 (øTX3) is higher than that of the first transfer transistor 501A (øTX1A). Also, the pulses øTX2A(n) to øTX2A(n+2) are at a low level. According to this, out of the charges generated in the PD 500 in this period, the charge that exceeds the potential barrier of the first transfer transistor 501A (øTX1A) remains in the PD 500 or the first signal holding unit 507A (MEM). Thus, the accumulation time period of each pixel in the Nth frame is started at the timing when the pulses øTX3(n) to øTX3(n+2) change to a low level at time t143.

When the pulses øTX1A(n) to øTX1A(n+2) change to a high level in a period from time t143 to time t144, the potential barrier formed in the first transfer transistor 501 A is eliminated. Accordingly, the charge generated in the PD 500 is transferred to the first signal holding unit 5074 (MEM) (FIG. 15E). Thereafter, the period in which the pulses øTX1A(n) to øTXIA(n+2) become a low level and the period in which these pulses become a high level are repeated a plurality of times up to time t145. Also, the pulses øTX3A(n) to øTX3A(n+2) perform driving in the manner in which the high level and the low level of the pulses øTX1A(n) to øTX1A(n+2) are reversed, from time t143 to time t145. Accordingly, the charges generated in the PD 500 in periods other than the period in which the pulses øTX1A(n) to øTXIA(n+2) are at a high level are drained to the OFD via the third transfer transistor 503(TX3). There is no particular limitation on the number of instances of transfer.

Adopting such a driving method makes it possible to periodically transfer the charge accumulated in the PD 500 to the first signal holding unit 507A (MEM). Also, accumulation for a predetermined time period is continuously carried out with a general driving method, whereas the driving method in the third embodiment includes a time period in which accumulation is performed a plurality of times in a predetermined time period and a time period with no accumulation, The image sensor 3 is capable of acquiring a desired proportion of the light amount over a plurality of times in the temporal direction that is acquired in the exposure time period from time t143 to time t145 and photoelectrically converted, utilizing a temporal relationship between this accumulation and non-accumulation,

When the pulses øTX3(n) to øTX3(n+2) are at a high level at the same time as when the pulses øTX1A(n) to øTX1A(n+2) are at a low level at time t145, the potential state of the pixel is as that shown in FIG. 15(F). Because the charges generated in the PD 500 at time t145 onward are drained to the OFD via the third transfer transistor 503, the charge accumulation time period of all of the pixels ends at time t5.

Then, simultaneously transferring the charges to the first signal holding unit 507A (MEM) from the PD 500 for all of the pixels makes it possible to synchronize the times when accumulation starts for all of the pixels and synchronize the times when accumulation ends for all of the pixels, and to realize an in-plane synchronous electronic shutter operation.

Next, the pulse øTX2A(n) reaches a high level at time t146 in the period from time t146 to time t148 in which the pulse øRES1(n) is at a low level. Accordingly, the charge held by the first signal holding unit 507A (MEM) of each pixel in the nth row is transferred to the FD region 508 via the second transfer transistor 502A (TX2A). The selection transistor 506 is on at at least this timing, and the level according to the amount of charge transferred to the FD region 508 by a source follower circuit formed by the amplifier transistor 505 and a constant electric current source appears in the vertical signal output line 523. A signal corresponding to the level appearing in the vertical signal output line 523 is output from the image sensor 3 via an output circuit (not shown),

A similar operation is performed for pixels in the (n+1)th row and the (n+2)th row, and signals corresponding to the pixels in the respective rows are output from the output circuit. Thus, operations for 1 frame are complete.

Note that, although the OFD is used as the charge drain region in the third embodiment, the present invention is not limited thereto. That is, a configuration may be adopted in which the third transfer transistor 503 is connected to the FD region 508, and a charge is drained to the power line before the second transfer transistor 502A transfers the charge from the first signal holding unit 507A to the FD region 508. With this method, a portion of the charge that is photoelectrically converted in the PD 500 is drained to the first signal holding unit 507A, and a portion of the charge is drained via the FD region 508, and an exposure amount adjustment operation is possible.

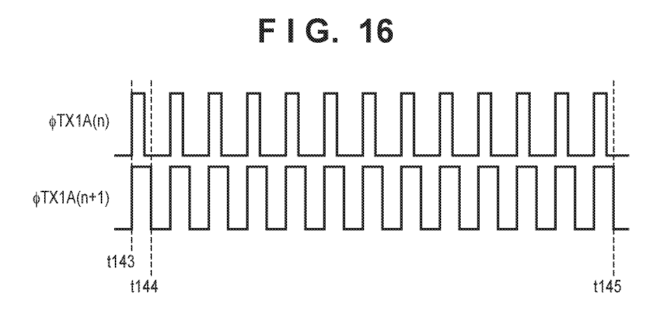

FIG. 16 is a timing chart that specifically shows the details of the pulses øTX1A(n) and øTX1A(n+1) shown in FIG. 14 from time t143 to time t145. Although, as described above, the pulse øTX1A is changed between a low level and a high level a plurality of times, as a result of which the imager ND function is achieved in this period, the charge accumulation time period may also be changed depending on the row. That is, the pulse widths of the pulse øTX1A at a high level for driving the first transfer transistors 501A in the nth row and the (n+1)th row may be set to be different from each other. This control is performed by the image sensor driving controller 4 changing a pulse control program in the vertical scanning circuit. FIG. 16 shows pulses in which the total accumulation time period for the nth row is shorter than that for the (n+1)th row. The image sensor 3 is an image sensor having color filters that are arranged in the form of a so-called Bayer array. lithe nth row is an RG row having RG color filters, the (n+1)th row is a GB row having GB color filters. If a difference in the pulse widths as in FIG. 16 is applied to the entire surface of the image sensor 3, the output result of an image in which the spectral transmittance of R is low with respect to that of B is obtained. Note that by allocating accumulation time periods evenly in one frame in this manner, frames are more smoothly connected to each other in a moving image and a natural moving image that appears more natural to a user can be obtained, compared to the case where a short accumulation time period is simply provided at the beginning of a frame within one frame.

Control Method

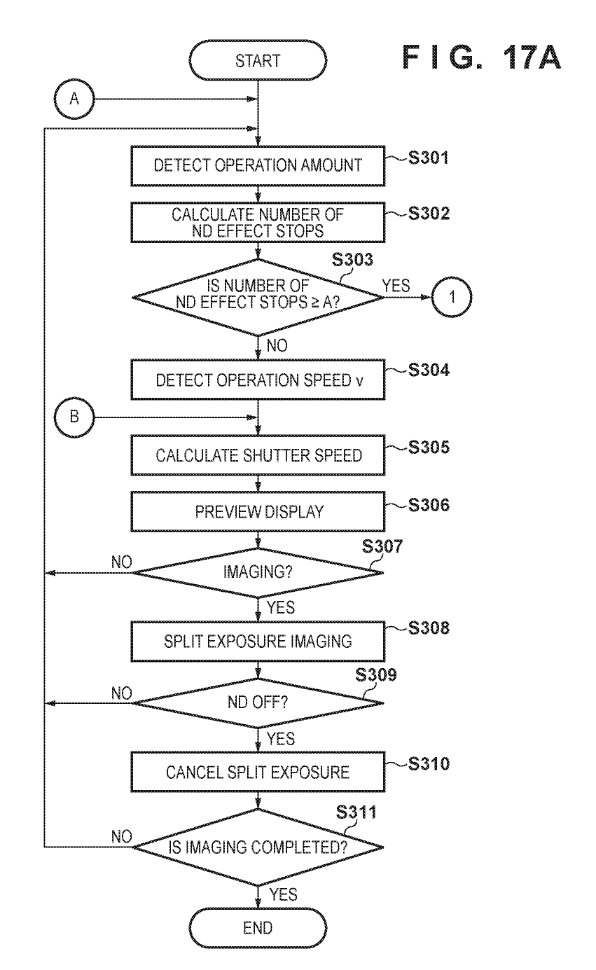

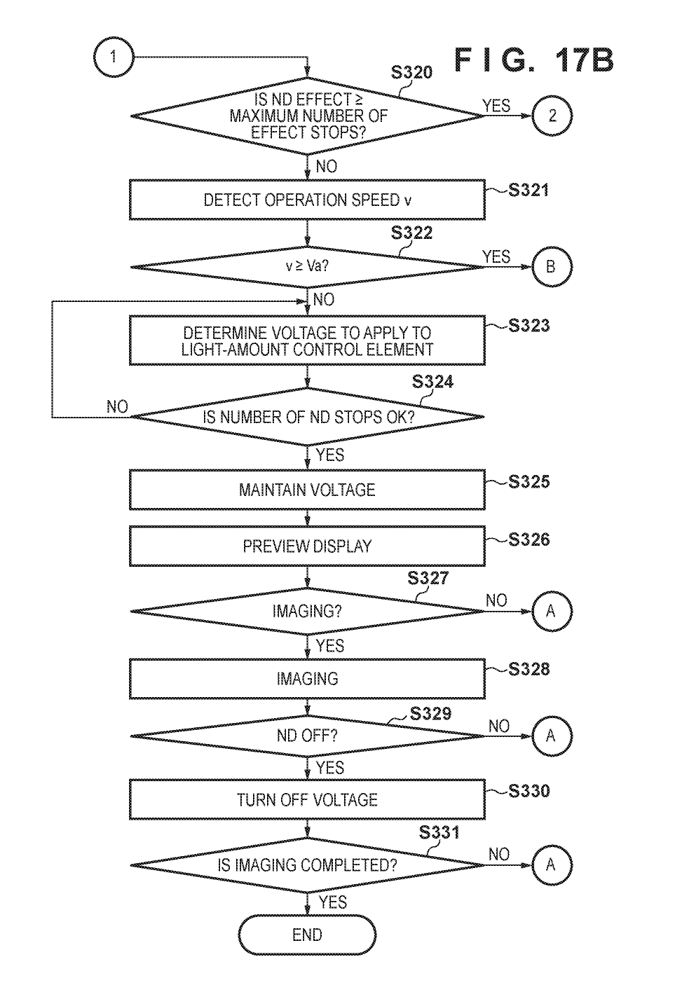

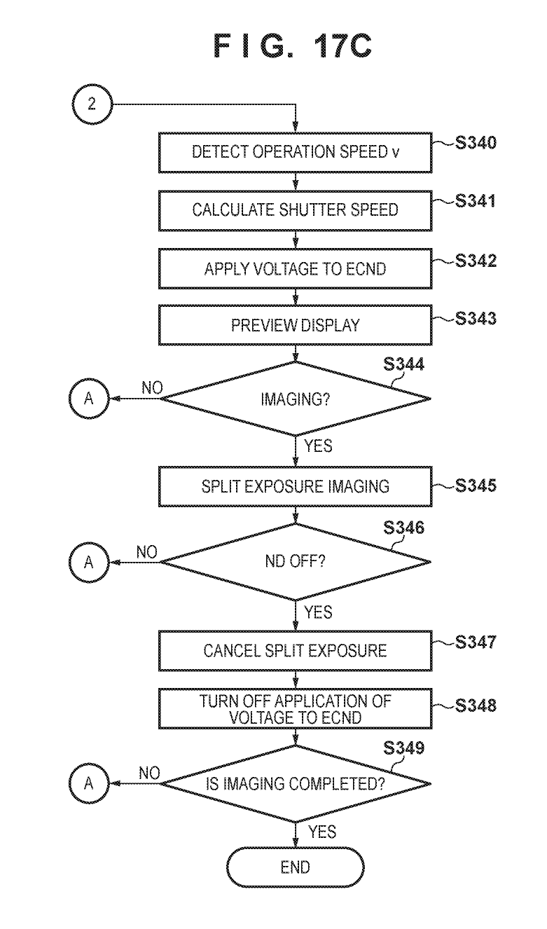

Next, the operations of the imager ND function and the light-amount control element 320 of the image sensor 3 in the third embodiment when the ND effect setting unit 303 is provided in the image capturing apparatus 300 will be described with reference to the flowcharts shown in FIGS. 17A to 17C.

The main CPU 30 detects an operation amount of the ND effect setting unit 303 in step S301. In step S302, the main CPU 30 calculates the number of ND effect stops set by the user, from the result of detection of the operation amount of the ND effect setting unit 303 in step S301.

The main CPU 30 determines in step S303 whether the number of ND effect stops set by the user is a predetermined value A or more, from the result calculated in step S302. As described above, this is because there is a problem in that, if the number of ND effect stops is controlled by the imager ND function, when the number of ND effect stops is increased, the control for the number of ND effect stops is limited to integer multiples of the pulse cycle for controlling the image capturing apparatus 300. Thus, if the number of ND effect stops set by the user is smaller than the predetermined value A, the number of ND effect stops is continuously controlled by the imager ND function with good. responsiveness. If the number of ND effect stops set by the user is the predetermined value A or more, the number of ND effect stops is continuously changed by controlling the transmittance using the light-amount control element 320.

If the number of ND effect stops set by the user is smaller than the predetermined value A in step S303, the number of ND effect stops is controlled by the imager ND function, and thus processing proceeds to step S304. On the other hand, if the number of ND effect stops set by the user is the predetermined value A or more, the number of ND effect stops is controlled by the light-amount control element 320, and thus processing proceeds to step S320. Note that a predetermined number of ND effect stops used in the determination in step S303 is a design value based on a time limit of signal processing of the image capturing apparatus 300, and thus can be set to any optional number.

The main CPU 30 detects an operation speed v of the ND effect setting unit 303 in step S304. In step S305, the ND control unit 9 calculates the number of ND effect stops desired by the user, the total accumulation time periods (shutter speed) that satisfy the rate of change, accumulation being performed using the imager ND function, and a change ratio between the total accumulation time periods, from the calculation result of the number of ND effect stops in step S302 and the operation speed v detected in step S304.

For example, if the user operates the ND effect setting unit 303 at a low speed, that is, if the operation speed v detected in step S304 is low, it is conceivable that the user is intentionally slowly changing the ND effect. In view of this, the amount of change in the total accumulation time periods between frames using the imager ND function is reduced, On the other hand, if the user operates the ND effect setting unit 303 at a high speed, that is, if the operation speed v detected in step S304 is high, the user is intentionally accelerating change in the ND effect, and thus the amount of change in the total accumulation time periods using the imager ND function is increased between frames.

That is, as a result of calculation in step S305, the image capturing apparatus 300 performs an operation described below in step S302, the number of ND effect stops set by the user is calculated as 3 stops, and if the operation speed v detected in step S304 is low, the number of ND effect stops is increased to 3 stops in 5 seconds, for example. On the other hand, if the operation speed v detected in step S304 is high, the number of ND effect stops is reduced to 3 stops in 1 second, for example. In this manner, the ND control unit 9 determines the amount of change in the total accumulation time periods between frames using the imager ND function based on the calculation result of the main CPU 30.

In step S306, the ND control unit 9 performs split exposure of the image sensor 3 via the image sensor driving controller 4 according to the total accumulation time periods that were calculated by the ND control unit 9 in step S305 using the imager ND function and the change ratio between these total accumulation time periods. Then, the main CPU 30 subjects the imaging luminous flux that has undergone the split exposure to image processing using the image processing unit 7, and displays the resulting image on the display unit 304 as a preview image.

In step S307, the main CPU 30 determines whether the imaging button 302 has been operated. If the imaging button 302 has been operated, processing proceeds to step S308, and if the imaging button 302 has not been operated, processing returns to step S301 and a series of operations are repeated.

On the other hand, in step S308. the image sensor 3 performs split exposure imaging according to the total accumulation time period that was calculated by the ND control unit 9 in step S305 using the imager ND function. In step S309, the main CPU 30 determines whether the ND effect setting unit 303 has been operated and the ND effect settings are off. Specifically, as a result of the main CPU 30 calculating the amount of operation made by the user on the ND effect setting unit 303, Whether the ND effect is not instructed is determined in step S309. As a result of the determination made by the main CPU 30, when the ND effect settings are off, processing proceeds to step S310, otherwise processing returns to step S301 and a series of operations are repeated.

In step S310, the ND control unit 9 stops split exposure imaging of the image sensor 3 and performs normal exposure imaging without performing splitting.

In step S311. the main CPU 30 determines whether the imaging button 302 has been operated. If the imaging button 302 has been operated by the user during an imaging operation up to step S310, the user intends to stop imaging. Thus, as a result of determination made by the main CPU 30 in step S311, when the imaging button 302 is operated, exposure and imaging using the image sensor 3 is stopped. On the other hand, if the imaging button 302 has not been operated, processing returns to step S301 and a series of operations are repeated.

Note that, although the case was described where if split exposure imaging using the image sensor 3 is stopped and the imaging button 302 is then operated, exposure and imaging using the image sensor 3 is stopped from step S301 to step S311, the present invention is not limited thereto. For example, if the imaging button 302 is operated in a state in which split exposure imaging is performed using the image sensor 3, even if exposure and imaging using the image sensor 3 is stopped, the present invention can be applied.

Next, processing in the case where, in step S303, the main CPU 30 determines that the number of ND effect stops set by the user is the predetermined value A or more will be described with reference to FIG. 17B.

In step S320, the main CPU 30 determines whether the number of ND effect stops calculated in step S303 is the maximum number of effect stops (that is, the state in which the light-amount control element 320 has the lowest transmittance) that can be adjusted by the light-amount control element 320 or more (out of an adjustable range). If the result calculated in step S302 is the predetermined value A or more and less than the maximum number of effect stops (within the adjustable range) that can be controlled by the light-amount control element 320, processing proceeds to step S321, and if it is the maximum number of effect stops that can be controlled by the light-amount control element 320 or more, processing proceeds to step S340.

The following describes the control in the case where the result calculated in step S302 is the predetermined value A or more and less than the maximum number of effect stops that can be controlled by the light-amount control element 320. Step S321 is similar to step S304, and thus a description thereof is omitted. In step S322, the main CPU 30 determines whether the operation speed v of the ND effect setting unit 303 that was detected in step S321 is larger than a predetermined value Va. This is performed to determine the speed of change in the number of ND effect stops as the intention of the user, according to the magnitude of the operation speed v of the ND effect setting unit 303. As described above, when the operation speed v of the ND effect setting unit 303 is high, the user is intentionally accelerating change in the number of ND effect stops, and when the operation speed v of the ND effect setting unit 303 is low, the user is intentionally slowing change in the number of ND effect stops. As described above, the light-amount control element 320 has a slower responsiveness than the imager ND function, and thus, when the operation speed v is high, the ND effect is suitably provided by the imager ND function.

Thus, whether the operation speed v of the ND effect setting unit 303 is larger than the predetermined value Va is determined in step S322, and if the operation speed v is the predetermined value Va or more, processing in step S305 and onward are performed, and the ND effect is provided by the imager ND function. Also, if the operation speed v of the ND effect setting unit 303 is less than the predetermined value Va, processing proceeds to step S323, and the ND effect is provided by the light-amount control element 320.

In step S323, the ECND controller 5 determines a voltage that is to be applied to the light-amount control element 320, according to the result calculated in step S302.

In step S324, the ECND controller 5 controls the transmittance by applying a voltage to the transparent electrodes 12a and 12b via the driving power source 16 so as to color the light-amount control element 320. Together with performing this control, the main CPU 30 subjects the imaging luminous flux that the image sensor 3 is exposed to via the colored light-amount control element 320 to image processing using the image processing unit 7, and compares the resulting image with the image before the light-amount control element 320 was colored. Then, the main CPU 30 determines whether the ND effect of the colored light-amount control element 320 coincides with the number of ND effect stops that is the result calculated in step S302 and set by the user, based on the comparison result.

As a result of the determination made by the main CPU 30 in step S324, if the ND effect of the light-amount control element 320 does not coincide with the number of ND effect stops that is the result calculated in step S302 and set by the user. the processing returns to step S323. At this time, the ECND controller 5 changes the voltage applied to the light-amount control element 320, and then processing proceeds to step S324. This supports a case where even if the same voltage applied to the light-amount control element 320, the coloring amount changes depending on the environment in which the image capturing apparatus 300 performs imaging, in particular, depending on the temperature.

As a result of the determination made by the main CPU 30 in step S324, if the ND effect of the light-amount control element 320 coincides with the number of ND effect stops that is the result calculated in step S302 and set by the user, the processing proceeds to step S325. In step S325, the main CPU 30 issues a command to the ECND controller 5 (ND control unit 9) so as to maintain the voltage that was applied to the transparent electrodes 12a and 12b of the light-amount control element 320 at the time of determination in step S324.

In step S326, the main CPU 30 subjects the imaging luminous flux that is exposed to the image sensor 3 via the light-amount control element 320 colored in the state in which the same ND effect as the number of ND effect stops set by the user is provided, to image processing using the image processing unit 7. Then, the main CPU 30 displays the resulting image on the display unit 304 as a preview image.

In step S327, the main CPU 30 determines whether the imaging button 302 has been operated. If the imaging button 302 has been operated, processing proceeds to step S328, and if the imaging button 302 has not been operated, processing returns to step S301 and a series of operations are repeated.

In step S328, the image that was exposed to the image sensor 3 via the light-amount control element 320 colored in the state in which the same ND effect as the number of ND effect stops set by the user is provided is recorded.

In step S329, the main CPU 30 determines whether the ND effect setting unit 303 has been operated and the ND effect settings are off. Specifically, as a result of the main CPU 30 calculating the amount of operation made by the user on the ND effect setting unit 303, whether the ND effect is not instructed is determined. As a result of the determination made by the main CPU 30, when the ND effect settings are off, processing proceeds to step S330, otherwise processing returns to step S301 and a series of operations are repeated.

In step S330, in order to stop performing imaging in the state in which the light-amount control element 320 is colored, the ND control unit 9 stops applying voltage to the light-amount control element 320 via the ECND controller 5, and continues normal exposure imaging in this state.

Similarly to step S311, in step S331, the main CPU 30 determines whether the imaging button 302 has been operated. If the imaging button 302 has been operated by the user during imaging operation up to step S330, the user intends to stop imaging. Thus, as a result of determination made by the main CPU 30 in step S331, when the imaging button 302 is operated, imaging using the image sensor 3 is stopped. On the other hand, if the imaging button 302 has not been operated, processing returns to step S301 and a series of operations are repeated.

Next, processing in the case where the number of ND effect stops calculated by the main CPU 30 in step S303 is the maximum number of effect stops that can be controlled by the light-amount control element 320 or more in step S320 will be described with reference to FIG. 17C.

With operations at step S340 and onward, the number of ND effect stops set by the user can be achieved as a result of providing the ND effect of the imager ND function while also providing the ND effect with the maximum number of effect stops that can be controlled by the light-amount control element 320.

Similarly to step S304, the main CPU 30 detects the operation speed v of the ND effect setting unit 303 in step S340. In step S341, the ND control unit 9 calculates the total accumulation time periods (shutter speed) that satisfy the number of ND effect stops that is desired by the user using the imager ND function, and calculates the change ratio between the total accumulation time periods, from the result of calculating the number of ND effect stops in step S302 and the operation speed v detected in step S340. At this time, the ND effect is provided by the imager ND function in an amount obtained by subtracting the maximum number of effect stops that can be controlled by the light-amount control element 320 from the number of ND effect stops set by the user. Thus, in step S341, the total accumulation time period (shutter speed) required for the imager ND function to provide the ND effect at the time of split exposure imaging of the image sensor 3 is calculated.

In step S342, the ECND controller 5 controls the transmittance by applying a voltage to the transparent electrodes 12a and 12b via the driving power source 16 to color the light-amount control element 320 so as to achieve the maximum number of effect stops that can be controlled by the light-amount control element 320.

In step S343, the ND control unit 9 performs split exposure of the image sensor 3 via the image sensor driving controller 4 according to the total accumulation time periods calculated by the ND control unit 9 in step S341 using the imager ND function and the change ratio between the total accumulation time periods. Furthermore, the main CPU 30 subjects the imaging luminous flux that is subjected to split exposure on the image sensor 3 via the light-amount control element 320 colored in the state in which the same ND effect as the number of ND effect stops set by the user is provided, to image processing using the image processing unit 7. Then, the main CPU 30 displays the resulting image on the display unit 304 as a preview image.

In step S344, the main CPU 30 determines whether the imaging button 302 has been operated. If the imaging button 302 has been operated, processing proceeds to step S345, and if the imaging button 302 has not been operated, processing returns to step S301 and a series of operations are repeated.

In step S345, the image sensor 3 performs split exposure imaging according to the total accumulation time period calculated by the ND control unit 9 in step S341 using the imager ND function.

In step S346, the main CPU 30 determines whether the ND effect setting unit 303 has been operated and the ND effect settings are off. Specifically, as a result of the main CPU 30 calculating the amount of operation made by the user on the ND effect setting unit 303, whether the ND effect is not instructed is determined. As a result of the determination made by the main CPU 30, when the ND effect settings are off, processing proceeds to step S347, otherwise processing returns to step S301 and a series of operations are repeated.

In step S347, the ND control unit 9 stops split exposure imaging of the image sensor 3 (the imager ND function) and performs normal exposure imaging without performing splitting.

In step S348, in order to stop performing exposure and imaging in the state in which the light-amount control element 320 is colored, the ND control unit 9 interrupts applying voltage to the light-amount control element 320 via the ECND controller 5. and continues normal exposure imaging in this state. Note that the operation in step S347 and the operation in step S348 are performed at approximately the same time.

In step S349, the main CPU 30 determines whether the imaging button 302 has been operated. If the imaging button 302 has been operated by the user during imaging operation up to step S348, the user intends to stop imaging. Thus, as a result of determination made by the main CPU 30 in step S349, when the imaging button 302 is operated, imaging using the image sensor 3 is stopped. On the other hand, if the imaging button 302 has not been operated, processing returns to step S301 and a series of operations are repeated.

As described above, according to the third embodiment, the ND effect can be continuously provided using at least one of the imager ND function and the light-amount control element 320 according to the user operation amount and the user operation speed of the ND effect setting unit 303.

That is, in the third embodiment, when the user operates an operation member in order to obtain a desired ND effect in the image capturing apparatus having two functions of controlling transmittance using an optically variable light attenuation unit and controlling transmittance using a digital variable light attenuation unit, it is possible to obtain the effect that the ND effect can be continuously provided.

### Fourth Embodiment

Next, a fourth embodiment of the present invention will be described. Although the EC material is used as the light-amount control element 320 in the above-described first embodiment, an electric light-amount control element in which liquid crystal is used may also be used.

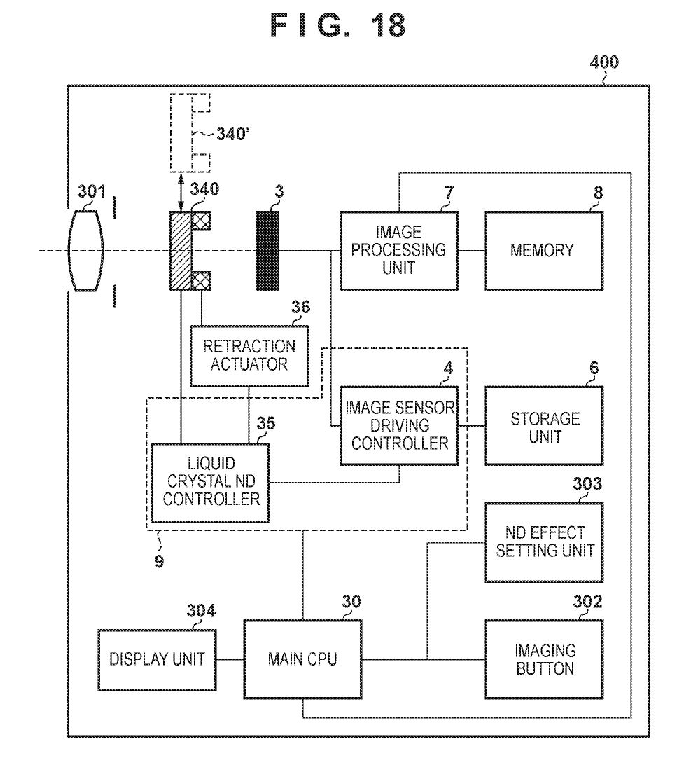

FIG. 18 is a block diagram showing a schematic functional configuration of an image capturing apparatus 400 having a light-amount control element 340 in which liquid crystal is used, instead of the light-amount control element 320. Note that the guest-host liquid crystal described with reference to FIGS. 9A to 9C in the second embodiment can be used as the light-amount control element 340 in which liquid crystal is used, for example. Also, the configuration of the image capturing apparatus 400 is different from that of the image capturing apparatus 300 shown in FIG. 12 in that a retraction actuator 36 for driving the light-amount control element 340 is added and a liquid crystal ND controller 35 is added instead of the ECND controller 5. Also, the liquid crystal ND controller 35 controls the voltage that is applied to the light-amount control element 340, and thereby the angle at which the liquid crystal material rotates varies, and the transmittance of the light-amount control element 340 changes. Accordingly, it is possible to attenuate the light amount passing through the light-amount control element 340, that is, to adjust the light attenuation amount of the light-amount control element 340.

Also, the retraction actuator 36 is constituted by a known motor, for example, and thus controls the position of the light-amount control element 340 based on a command issued by the liquid crystal ND controller 35. Specifically, the retraction actuator 36 can move the light-amount control element 340 between a position in the light path that passes through the imaging optical system 301 and forms an image on the image sensor 3 (the position indicated by a solid line) and a position 340′ to which the light-amount control element 340 is retracted from the light path (the position depicted by a broken line). The configurations other than the above are similar to those shown in FIG. 12, and thus the same configurations are given the same reference numerals and a description thereof will be omitted.

In the fourth embodiment, an image sensor driving controller 4 controls the light attenuation amount based on the detection result of a liquid crystal coloring detection unit (not shown) for detecting a colored state of the light-amount control element 340 and the characteristic values of the light-amount control element 340 stored in a storage unit 6 of the image capturing apparatus 400.

Control Method

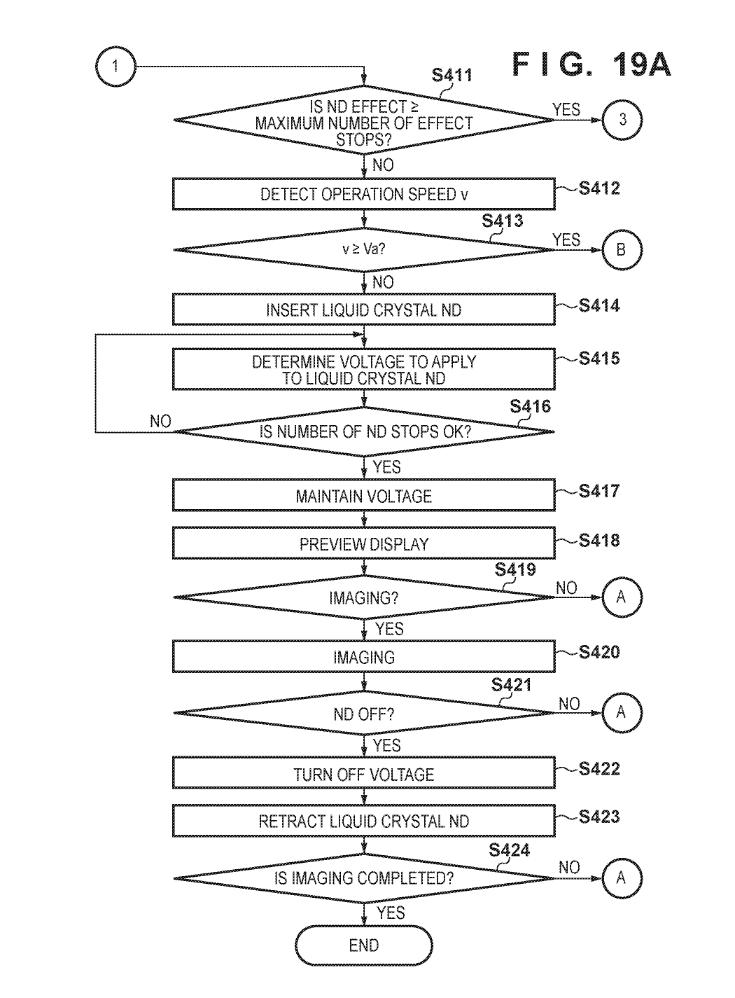

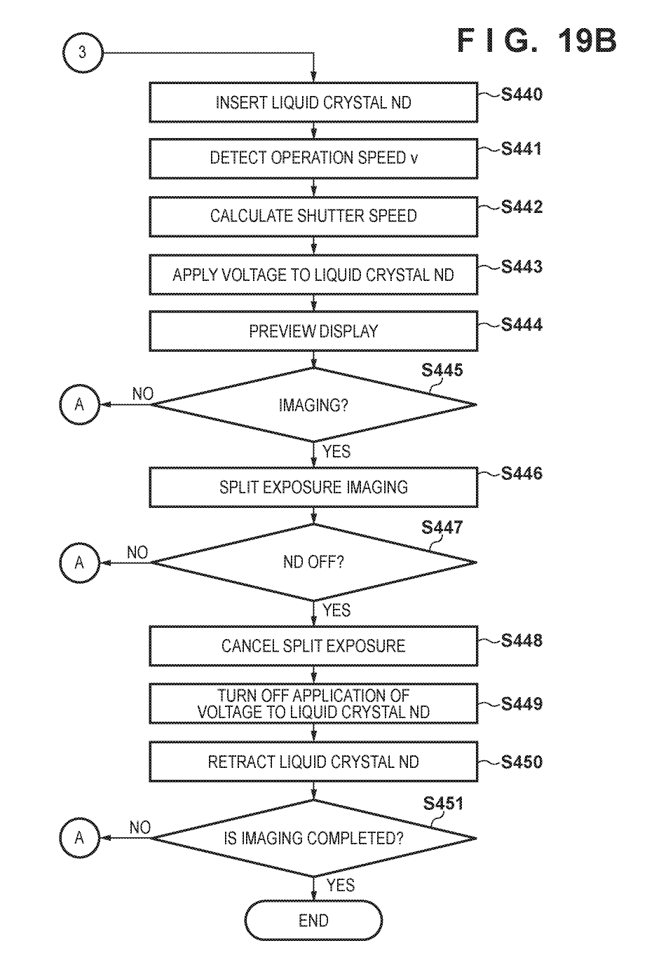

Next, the operations of the imager ND function and the light-amount control element 340 of the image sensor 3 in the fourth embodiment when the ND effect setting unit 303 is provided in the image capturing apparatus 400 will be described with reference to the flowcharts shown in FIGS. 19A and 19B. Note that the control performed when the number of ND effect stops set by the user is smaller than a predetermined value A is similar to the control described with reference to FIG. 17A in the third embodiment, and thus a description thereof will be omitted, but the control is performed in the state in which the light-amount control element 340 is retracted from the light path in the fourth embodiment.

If the number of ND effect stops set by the user is the predetermined value A or more, the number of ND effect stops is controlled by the light-amount control element 340, and thus processing proceeds to step S411 shown in FIG. 19A.

In step S411. the main CPU 30 determines whether the number of ND effect stops calculated in step S303 is the maximum number of effect stops that can be adjusted by the light-amount control element 340 (that is, the state in which the light-amount control element 340 has the lowest transmittance) or more (out of an adjustable range). If the result calculated in step S302 is the predetermined value A or more and less than the maximum number of effect stops (within the adjustable range) that can be controlled by the light-amount control element 340, processing proceeds to step S412, and if it is the maximum number of effect stops that can be controlled by the light-amount control element 340 or more, processing proceeds to step S440 shown in FIG. 19B.

The following describes the control in the case where the result calculated in step S302 is the predetermined value A or more and less than the maximum number of effect stops that can be controlled by the light-amount control element 340. Step S412 is similar to step S304, and thus a description thereof will be omitted. In step S413, the main CPU 30 determines whether the operation speed v of the ND effect setting unit 303 that was detected in step S412 is larger than a predetermined value Va. The reason why this determination is made here is similar to that in step S322. Thus, if the operation speed v is the predetermined value Va or more, processing in step S305 and onward are performed, and the ND effect is provided by the imager ND function. Also, if the operation speed v of the ND effect setting unit 303 is less than the predetermined value Va, processing proceeds to step S414, and the light-amount control element 340 is inserted into the imaging light path.

In step S415, the liquid crystal ND controller 35 determines a voltage that is to be applied to the light-amount control element 340, according to the result calculated in step S302.

In step S416, the liquid crystal ND controller 35 controls the transmittance by applying a voltage to transparent electrodes 202a and 202b so as to color the light-amount control element 340. Together with performing this control, the main CPU 30 subjects the imaging luminous flux exposed to the image sensor 3 via the colored light-amount control element 340 to image processing using the image processing unit 7, and compares the resulting image with the image before the light-amount control element 340 is colored. Then, the main CPU 30 determines whether the ND effect of the colored light-amount control element 340 coincides with the number of ND effect stops that is the result calculated in step S302 and set by the user, based on the comparison result.

As a result of the determination made by the main CPU 30 in step S416, if the ND effect of the light-amount control element 340 does not coincide with the number of ND effect stops that is the result calculated in step S302 and set by the user, the processing returns to step S415. At this time, the liquid crystal ND controller 35 changes the voltage applied to the light-amount control element 340, and then processing proceeds to step S415. This supports the case where even if the same voltage is applied to the light-amount control element 340, the coloring amount changes depending on the environment in which the image capturing apparatus 400 performs imaging, in particular, depending on the temperature.

As a result of the determination made by the main CPU 30 in step S416, if the ND effect of the light-amount control element 340 coincides with the number of ND effect stops that is the result calculated in step S302 and set by the user, the processing proceeds to step S417. In step S417, the main CPU 30 issues a command to the liquid crystal ND controller 35 (ND control unit 9) so as to maintain the voltage that was applied to the transparent electrodes 202a and 202b of the light-amount control element 340 at the time of determination in step S416.

In step S418, the main CPU 30 subjects the imaging luminous flux that the image sensor 3 is exposed to via the light-amount control element 340 colored in the state in which the same ND effect as the number of ND effect stops set by the user is provided, to image processing using the image processing unit 7. Then, the main CPU 30 displays the resulting image on the display unit 304 as a preview image.

In step S419, the main CPU 30 determines whether the imaging button 302 has been operated. If the imaging button 302 has been operated, processing proceeds to step S420, and if the imaging button 302 has not been operated, processing returns to step S301 and a series of operations are repeated.

In step S420, the imaging luminous flux that was exposed to the image sensor 3 via the light-amount control element 340 colored in the state in which the same ND effect as the number of ND effect stops set by the user is provided is recorded.

In step S421, the main CPU 30 determines whether the ND effect setting unit 303 has been operated and the ND effect settings are off. Specifically, as a result of the main CPU 30 calculating the amount of operation made by the user on the ND effect setting unit 303, whether the ND effect is not instructed is determined. As a result of the determination made by the main CPU 30, when the ND effect settings are off, processing proceeds to step S422, otherwise processing returns to step S301 and a series of operations are repeated.

In step S422, the ND control unit 9 interrupts applying voltage to the light-amount control element 340 via the liquid crystal ND controller 35. Furthermore, the ND control unit 9 controls the retraction actuator 36 in step S423 so as to retract the light-amount control element 340 from the light path, and continues performing normal imaging in this state. Note that the operation in step S422 and the operation in step S423 are performed at approximately the same time.

Similarly to step S311, in step S424, the main CPU 30 determines whether the imaging button 302 has been operated. If the imaging button 302. has been operated by the user during imaging operation up to step S423, the user intends to stop imaging. Thus, as a result of determination made by the main CPU 30 in step S424, when the imaging button 302 is operated, imaging using the image sensor 3 is stopped. On the other hand, if the imaging button 302 has not been operated, processing returns to step S301 and a series of operations are repeated.

Next, processing in the case where the main CPU 30 determines that the number of ND effect stops in step S303 is the maximum number of effect stops that can be controlled by the light-amount control element 340 or more in step S411 will be described with reference to FIG. 19B.

With operations at step S440 and onward, as will be described later, the number of ND effect stops set by the user can be achieved as a result of providing the ND effect of the imager ND function while also providing the ND effect with the maximum number of effect stops that can be controlled by the light-amount control element 340.

In step S440, first, the light-amount control element 340 is inserted into the imaging light path. Similarly to step S304, the main CPU 30 detects the operation speed v of the ND effect setting unit 303 in step S441. In step S442, the ND control unit 9 calculates the total accumulation time periods (shutter speed) that satisfy the number of ND effect stops that is desired by the user using the imager ND function, and calculates the change ratio between the total accumulation time periods, from the result of calculating the number of ND effect stops in step S302 and the operation speed v detected in step S441. At this time, the ND effect is provided by the imager ND function in an amount obtained by subtracting the maximum number of effect stops that can be controlled by the light-amount control element 340 from the number of ND effect stops set by the user. Thus, in step S442, the total accumulation time period (shutter speed) required for the imager ND function to provide the ND effect at the time of split exposure imaging of the image sensor 3 is calculated.

In step S443, the liquid crystal ND controller 35 controls the transmittance by applying a voltage to the transparent electrodes 202a and 202b to color the light-amount control element 340 so as to achieve the maximum number of effect stops that can be controlled by the light-amount control element 340.

In step S444, the ND control unit 9 performs split exposure of the image sensor 3 via the image sensor driving controller 4 according to the total accumulation time periods calculated by the ND control unit 9 in step S442 using the imager ND function. Furthermore, the main CPU 30 subjects the imaging luminous flux that was subjected to split exposed on the image sensor 3 via the light-amount control element 340 colored in the state in which the same ND effect as the number of ND effect stops set by the user is provided, to image processing using the image processing unit 7. Then, the main CPU 30 displays the resulting image on the display unit 304 as a preview image.

In step S445, the main CPU 30 determines whether the imaging button 302 has been operated. If the imaging button 302 has been operated, processing proceeds to step S446, and if the imaging button 302 has not been operated, processing returns to step S301 and a series of operations are repeated.

In step S446, the image sensor 3 performs split exposure imaging according to the total accumulation time periods calculated by the ND control unit 9 in step S442 using the imager ND function.

In step S447, the main CPU 30 determines whether the ND effect setting unit 303 has been operated and the ND effect settings are off. Specifically, as a result of the main CPU 30 calculating the amount of operation made by the user on the ND effect setting unit 303, whether the ND effect is not instructed is determined. As a result of the determination made by the main CPU 30. when the ND effect settings are off, processing proceeds to step S448, otherwise processing returns to step S301 and a series of operations are repeated.

In step S448, the ND control unit 9 stops split exposure imaging of the image sensor 3 (the imager ND function) and performs normal imaging without performing splitting.

In step S449, in order to stop performing exposure and imaging in the state in which the light-amount control element 340 is colored, the ND control unit 9 stops applying voltage to the light-amount control element 340 via the liquid crystal ND controller 35. Furthermore, the ND control unit 9 controls the retraction actuator 36 in step S450 so as to retract the light-amount control element 340 from the light path, and continues performing normal imaging in this state. Note that operations from step S448 to step S450 are performed at approximately the same time.

In step S451, the main CPU 30 determines whether the imaging button 302 has been operated. If the imaging button 302 has been operated by the user during imaging operation up to step S450, the user intends to stop imaging. Thus, as a result of determination made by the main CPU 30 in step S451, when the imaging button 302 is operated, imaging using the image sensor 3 is stopped. On the other hand, if the imaging button 302 has not been operated, processing returns to step S301 and a series of operations are repeated.

As described above, according to the fourth embodiment, even if the liquid crystal ND is used, effects that are similar to those of the third embodiment can also be obtained.

Note that the present invention may also be applied to a system constituted by a plurality of devices, or may also be applied to an apparatus constituted by one device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-008164, filed on Jan. 22, 2018, which is hereby incorporated by reference herein in its entirety.

What is clamed is:

1. An image capturing apparatus comprising one or more processors and/or circuitry which functions as:
a light-amount control element that changes a transmittance of light;
an image sensor that photoelectrically converts light that has passed through the light-amount control element and changes an exposure amount by intermittently accumulating charges in a predetermined cycle in each frame; and
a controller that controls the transmittance of the light-amount control element and the exposure amount controlled by the image sensor so as to achieve a preset target exposure amount.

2. The image capturing apparatus according to claim 1, wherein the one or more processors and/or circuitry further functions as
a photometry unit,
wherein, in a case where a light attenuation amount based on a photometry value obtained by the photometry unit and the target exposure amount is larger than a predetermined value, the controller determines the transmittance of the light-amount control element and the exposure amount controlled by the image sensor so as to achieve the target exposure amount.

3. The image capturing apparatus according to claim 2,
wherein the controller determines the exposure amount that can be set by the image sensor based on the target exposure amount, and determines the transmittance of the light-amount control element so as to achieve a light attenuation amount corresponding to a difference between the exposure amount controlled by the image sensor and the target exposure amount.

4. The image capturing apparatus according to claim 3,
wherein the controller determines the exposure amount to he controlled by the image sensor so that the exposure amount is the target exposure amount or more and is closest to the target exposure amount.

5. The image capturing apparatus according to claim 2,
wherein the light-amount control element is an organic electrochromic device.

6. The image capturing apparatus according to claim 2,
wherein the light-amount control element is a liquid crystal element.

7. The image capturing apparatus according to claim 6,
wherein, in a case where the light attenuation amount is smaller than a light attenuation amount of light that can pass through the light-amount control element at the maximum transmittance of the light-amount control element, the controller retracts the light-amount control element from a light path and determines the exposure amount controlled by the image sensor so as to achieve a target exposure amount based on the light attenuation amount.

8. The image capturing apparatus according to claim 1, wherein the one or more processors and/or circuitry further functions as
an instruction unit that designates a light attenuation amount and a speed for reaching the light attenuation amount,
wherein the controller controls at least one of the transmittance of the light-amount control element and the exposure amount controlled by the image sensor according to the light attenuation amount and the speed designated by the instruction unit.

9. The image capturing apparatus according to claim 8,
wherein, in a case where the speed is higher than a predetermined speed and the light attenuation amount is in an adjustable range that is adjustable by, the transmittance of the light-amount control element, the controller controls the exposure amount controlled by the image sensor.

10. The image capturing apparatus according to claim 8,
wherein, in a case where the speed is lower than a predetermined speed and the light attenuation amount is in an adjustable range that is adjustable by the transmittance of the light-amount control element, the controller controls the transmittance of the light-amount control element.

11. The image capturing apparatus according to claim 8,
wherein, in a case where the light attenuation amount is beyond an adjustable range that is adjustable by the transmittance of the light-amount control element, the controller controls the transmittance of the light-amount control element and the exposure amount controlled by the image sensor.

12. The image capturing apparatus according to claim 9,
wherein a change in the exposure amount according to the image sensor between frames is made smaller in a case where the speed is a first speed than in a case where the speed is a second speed that is higher than the first speed.

13. The image capturing apparatus according to claim 8,
wherein the light-amount control element is an organic electrochromic device.

14. The image capturing apparatus according to claim 8,
wherein the light-amount control element is a liquid crystal element.

15. The image capturing apparatus according to claim 14,
wherein, in a case where the light attenuation amount is not designated by the instruction unit, the controller retracts the light-amount control element from a light path.

16. A method for controlling an image capturing apparatus including a light-amount control element that changes a transmittance of light and an image sensor that photoelectrically converts light that has passed through the light-amount control element and changes an exposure amount by intermittently accumulating charges in a predetermined cycle in each frame, the method comprising:
acquiring a light attenuation amount; and
controlling the transmittance of the light-amount control element and the exposure amount controlled by the image sensor so as to achieve a target exposure amount that is based on the light attenuation amount.
